SEQUENCE LISTING (19 sequences)

SEQ ID NO: 1 - protein, 901 aa, Streptococcus agalactiae
MRKYQKFSKILTLSLFCLSQIPLNTNVLGESTVPENGAKGKLVVKKTDDQNKPLSKATFVLKTTAHPESKIEKVTAELTGEATFDNLIPGDYTLSEETAPEGYKKTNQTWQVKVESNGKTTIQNSGDKNSTIGQNQEELDKQYPPTGIYEDTKESYKLEHVKGSVPNGKSEAKAVNPYSSEGEHIREIPEGTLSKRISEVGDLAHNKYKIELTVSGKTIVKPVDKQKPLDVVFVLDNSNSMNNDGPNFQRHNKAKKAAEALGTAVKDILGANSDNRVALVTYGSDIFDGRSVDVVKGFKEDDKYYGLQTKFTIQTENYSHKQLTNNAEEIIKRIPTEAPKAKWGSTTNGLTPEQQKEYYLSKVGETFTMKAFMEADDILSQVNRNSQKIIVHVTDGVPTRSYAINNFKLGASYESQFEQMKKNGYLNKSNFLLTDKPEDIKGNGESYFLFPLDSYQTQIISGNLQKLHYLDLNLNYPKGTIYRNGPVKEHGTPTKLYINSLKQKNYDIFNFGIDISGFRQVYNEEYKKNQDGTFQKLKEEAFKLSDGEITELMRSFSSKPEYYTPIVTSADTSNNEILSKIQQQFETILTKENSIVNGTIEDPMGDKINLQLGNGQTLQPSDYTLQGNDGSVMKDGIATGGPNNDGGILKGVKLEYIGNKLYVRGLNLGEGQKVTLTYDVKLDDSFISNKFYDTNGRTTLNPKSEDPNTLRDFPIPKIRDVREYPTITIKNEKKLGEIEFIKVDKDNNKLLLKGATFELQEFNEDYKLYLPIKNNNSKVVTGENGKISYKDLKDGKYQLIEAVSPEDYQKITNKPILTFEVVKGSIKNIIAVNKQISEYHEEGDKHLITNTHIPPKGIIPMTGGKGILSFILIGGAMMSIAGGIYIWKRYKKSSDMSIKKD

SEQ ID NO: 2 - protein, 554 aa, Streptococcus agalactiae
MKLSKKLLFSAAVLTMVAGSTVEPVAQFATGMSIVRAAEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKGMTLVKNQDALDKATANTDDAAFLEIPVASTINEKAVLGKAIENTFELQYDHTPDKADNPKPSNPPRKPEVHTGGKRFVKKDSTETQTLGGAEFDLLASDGTAVKWTDALIKANTNKNYIAGEAVTGQPIKLKSHTDGTFEIKGLAYAVDANAEGTAVTYKLKETKAPEGYVIPDKEIEFTVSQTSYNTKPTDITVDSADATPDTIKNNKRPSIPNTGGIGTAIFVAIGAAVMAFAVKGMKRRTKDN

SEQ ID NO: 3 - protein, 890 aa, Streptococcus agalactiae
MKKRQKIWRGLSVTLLILSQIPFGILVQGETQDTNQALGKVIVKKTGDNATPLGKATFVLKNDNDKSETSHETVEGSGEATFENIKPGDYTLREETAPIGYKKTDKTWKVKVADNGATIIEGMDADKAEKRKEVLNAQYPKSAIYEDTKENYPLVNVEGSKVGEQYKALNPINGKDGRREIAEGWLSKKITGVNDLDKNKYKIELTVEGKTTVETKELNQPLDVVVLLDNSNSMNNERANNSQRALKAGEAVEKLIDKITSNKDNRVALVTYASTIFDGTEATVSKGVADQNGKALNDSVSWDYHKTTFTATTHNYSYLNLTNDANEVNILKSRIPKEAEHINGDRTLYQFGATFTQKALMKANEILETQSSNARKKLIFHVTDGVPTMSYAINFNPYISTSYQNQFNSFLNKIPDRSGILQEDFIINGDDYQIVKGDGESFKLFSDRKVPVTGGTTQAAYRVPQNQLSVMSNEGYAINSGYIYLYWRDYNWVYPFDPKTKKVSATKQIKTHGEPTTLYFNGNIRPKGYDIFTVGIGVNGDPGATPLEAEKFMQSISSKTENYTNVDDTNKIYDELNKYFKTIVEEKHSIVDGNVTDPMGEMIEFQLKNGQSFTHDDYVLVGNDGSQLKNGVALGGPNSDGGILKDVTVTYDKTSQTIKINHLNLGSGQKVVLTYDVRLKDNYISNKFYNTNNRTTLSPKSEKEPNTIRDFPIPKIRDVREFPVLTISNQKKMGEVEFIKVNKDKHSESLLGAKFQLQIEKDFSGYKQFVPEGSDVTTKNDGKIYFKALQDGNYKLYEISSPDGYIEVKTKPVVTFTIQNGEVTNLKADPNANKNQIGYLEGNGKHLITNTPKRPPGVFPKTGGIGTIVYILVGSTFMILTICSFRRKQL

SEQ ID NO: 4 - protein, 1134 aa, Streptococcus agalactiae
MRKKQKLPFDKLAIALISTSILLNAQSDIKANTVTEDTPATEQAVEPPQPIAVSEESRSSKETKTSQTPSDVGETVADDANDLAPQAPAKTADTPATSKATIRDLNDPSHVKTLQEKAGKGAGTVVAVIDAGFDKNHEAWRLTDKTKARYQSKENLEKAKKEHGITYGEWVNDKVAYYHDYSKDGKNAVDQEHGTHVSGILSGNAPSEMKEPYRLEGAMPEAQLLLMRVEIVNGLADYARNYAQAIRDAVNLGAKVINMSFGNAALAYANLPDETKKAFDYAKSKGVSIVTSAGNDSSFGGKPRLPLADHPDYGVVGTPAAADSTLTVASYSPDKQLTETATVKTDDHQDKEMPVISTNRFEPNKAYDYAYANRGTKEDDFKDVEGKIALIERGDIDFKDKIANAKKAGAVGVLIYDNQDKGFPIELPNVDQMPAAFISRRDGLLLKDNPPKTITFNATPKVLPTASGTKLSRFSSWGLTADGNIKPDIAAPGQDILSSVANNKYAKLSGTSMSAPLVAGIMGLLQKQYETQYPDMTPSERLDLAKKVLMSSATALYDEDEKAYFSPRQQGAGAVDAKKASAATMYVTDKDNTSSKVHLNNVSDKFEVTVTVHNKSDKPQELYYQVTVQTDKVDGKHFALAPKALYETSWQKITIPANSSKQVTVPIDASRFSKDLLAQMKNGYFLEGFVRFKQDPTKEELMSIPYIGFRGDFGNLSALEKPIYDSKDGSSYYHEANSDAKDQLDGDGLQFYALKNNFTALTTESNPWTIIKAVKEGVENIEDIESSEITETIFAGTFAKQDDDSHYYIHRHANGKPYAAISPNGDGNRDYVQFQGTFLRNAKNLVAEVLDKEGNVVWTSEVTEQVVKNYNNDLASTLGSTRFEKTRWDGKDKDGKVVANGTYTYRVRYTPISSGAKEQHTDFDVIVDNTTPEVATSATFSTEDSRLTLASKPKTSQPVYRERIAYTYMDEDLPTTEYISPNEDGTFTLPEEAETMEGATVPLKMSDFTYVVEDMAGNITYTPVTKLLEGHSNKPEQDGSDQAPDKKPEAKPEQDGSGQTPDKKKETKPEKDSSGQTPGKTPQKGQSSRTLEKRSSKRALATKASTRDQLPTTNDKDTNRLHLLKLVMTTFFLG

SEQ ID NO: 5 - protein, 432 aa, Streptococcus agalactiae
MNKKVLLTSTMAASLLSVASVQAQETDTTWTARTVSEVKADLVKQDNKSSYTVKYGDTLSVISEAMSIDMNVLAKINNIADINLIYPETTLTVTYDQKSHTATSMKIETPATNAAGQTTATVDLKTNQVSVADQKVSLNTISEGMTPEAATTIVSPMKTYSSAPALKSKEVLAQEQAVSQAAANEQVSPAPVKSITSEVPAAKEEVKPTQTSVSQSTTVSPASVAAETPAPVAKVAPVRTVAAPRVASVKVVTPKVETGASPEHVSAPAVPVTTTSPATDSKLQATEVKSVPVAQKAPTATPVAQPASTTNAVAAHPENAGLQPHVAAYKEKVASTYGVNEFSTYRAGDPGDHGKGLAVDFIVGTNQALGNKVAQYSTQNMAANNISYVIWQQKFYSNTNSIYGPANTWNAMPDRGGVTANHYDHVHVSFNK

SEQ ID NO: 6 - protein, 517 aa, Streptococcus agalactiae
AEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKGMTLVKNQDALDKATANTDDAAFLEIPVASTINEKAVLGKAIENTFELQYDHTPDKADNPKPSNPPRKPEVHTGGKRFVKKDSTETQTLGGAEFDLLASDGTAVKWTDALIKANTNKNYIAGEAVTGQPIKLKSHTDGTFEIKGLAYAVDANAEGTAVTYKLKETKAPEGYVIPDKEIEFTVSQTSYNTKPTDITVDSADATPDTIKNNKRPSIPNTGGIGTAIFVAIGAAVMAFAVKGMKRRTKDN

SEQ ID NO: 7 - protein, 525 aa, Streptococcus agalactiae
MKLSKKLLFSAAVLTMVAGSTVEPVAQFATGMSIVRAAEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKGMTLVKNQDALDKATANTDDAAFLEIPVASTINEKAVLGKAIENTFELQYDHTPDKADNPKPSNPPRKPEVHTGGKRFVKKDSTETQTLGGAEFDLLASDGTAVKWTDALIKANTNKNYIAGEAVTGQPIKLKSHTDGTFEIKGLAYAVDANAEGTAVTYKLKETKAPEGYVIPDKEIEFTVSQTSYNTKPTDITVDSADATPDTIKNNKRPSIPNTG

SEQ ID NO: 8 - protein, 520 aa, Streptococcus agalactiae
MKLSKKLLFSAAVLTMVAGSTVEPVAQFATGMSIVRAAEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKGMTLVKNQDALDKATANTDDAAFLEIPVASTINEKAVLGKAIENTFELQYDHTPDKADNPKPSNPPRKPEVHTGGKRFVKKDSTETQTLGGAEFDLLASDGTAVKWTDALIKANTNKNYIAGEAVTGQPIKLKSHTDGTFEIKGLAYAVDANAEGTAVTYKLKETKAPEGYVIPDKEIEFTVSQTSYNTKPTDITVDSADATPDTIKNNKRPS

SEQ ID NO: 9 - protein, 483 aa, Streptococcus agalactiae
AEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKGMTLVKNQDALDKATANTDDAAFLEIPVASTINEKAVLGKAIENTFELQYDHTPDKADNPKPSNPPRKPEVHTGGKRFVKKDSTETQTLGGAEFDLLASDGTAVKWTDALIKANTNKNYIAGEAVTGQPIKLKSHTDGTFEIKGLAYAVDANAEGTAVTYKLKETKAPEGYVIPDKEIEFTVSQTSYNTKPTDITVDSADATPDTIKNNKRPS

SEQ ID NO: 10 - protein, 271 aa, Streptococcus agalactiae
AEVSQERPAKTTVNIYKLQADSYKSEITSNGGIENKDGEVISNYAKLGDNVKGLQGVQFKRYKVKTDISVDELKKLTTVEAADAKVGTILEEGVSLPQKTNAQGLVVDALDSKSNVRYLYVEDLKNSPSNITKAYAVPFVLELPVANSTGTGFLSEINIYPKNVVTDEPKTDKDVKKLGQDDAGYTIGEEFKWFLKSTIPANLGDYEKFEITDKFADGLTYKSVGKIKIGSKTLNRDEHYTIDEPTVDNQNTLKITFKPEKFKEIAELLKG

SEQ ID NO: 11 - protein, 862 aa, Streptococcus agalactiae
GETQDTNQALGKVIVKKTGDNATPLGKATFVLKNDNDKSETSHETVEGSGEATFENIKPGDYTLREETAPIGYKKTDKTWKVKVADNGATIIEGMDADKAEKRKEVLNAQYPKSAIYEDTKENYPLVNVEGSKVGEQYKALNPINGKDGRREIAEGWLSKKITGVNDLDKNKYKIELTVEGKTTVETKELNQPLDVVVLLDNSNSMNNERANNSQRALKAGEAVEKLIDKITSNKDNRVALVTYASTIFDGTEATVSKGVADQNGKALNDSVSWDYHKTTFTATTHNYSYLNLTNDANEVNILKSRIPKEAEHINGDRTLYQFGATFTQKALMKANEILETQSSNARKKLIFHVTDGVPTMSYAINFNPYISTSYQNQFNSFLNKIPDRSGILQEDFIINGDDYQIVKGDGESFKLFSDRKVPVTGGTTQAAYRVPQNQLSVMSNEGYAINSGYIYLYWRDYNWVYPFDPKTKKVSATKQIKTHGEPTTLYFNGNIRPKGYDIFTVGIGVNGDPGATPLEAEKFMQSISSKTENYTNVDDTNKIYDELNKYFKTIVEEKHSIVDGNVTDPMGEMIEFQLKNGQSFTHDDYVLVGNDGSQLKNGVALGGPNSDGGILKDVTVTYDKTSQTIKINHLNLGSGQKVVLTYDVRLKDNYISNKFYNTNNRTTLSPKSEKEPNTIRDFPIPKIRDVREFPVLTISNQKKMGEVEFIKVNKDKHSESLLGAKFQLQIEKDFSGYKQFVPEGSDVTTKNDGKIYFKALQDGNYKLYEISSPDGYIEVKTKPVVTFTIQNGEVTNLKADPNANKNQIGYLEGNGKHLITNTPKRPPGVFPKTGGIGTIVYILVGSTFMILTICSFRRKQL

SEQ ID NO: 12 - protein, 851 aa, Streptococcus agalactiae
MKKRQKIWRGLSVTLLILSQIPFGILVQGETQDTNQALGKVIVKKTGDNATPLGKATFVLKNDNDKSETSHETVEGSGEATFENIKPGDYTLREETAPIGYKKTDKTWKVKVADNGATIIEGMDADKAEKRKEVLNAQYPKSAIYEDTKENYPLVNVEGSKVGEQYKALNPINGKDGRREIAEGWLSKKITGVNDLDKNKYKIELTVEGKTTVETKELNQPLDVVVLLDNSNSMNNERANNSQRALKAGEAVEKLIDKITSNKDNRVALVTYASTIFDGTEATVSKGVADQNGKALNDSVSWDYHKTTFTATTHNYSYLNLTNDANEVNILKSRIPKEAEHINGDRTLYQFGATFTQKALMKANEILETQSSNARKKLIFHVTDGVPTMSYAINFNPYISTSYQNQFNSFLNKIPDRSGILQEDFIINGDDYQIVKGDGESFKLFSDRKVPVTGGTTQAAYRVPQNQLSVMSNEGYAINSGYIYLYWRDYNWVYPFDPKTKKVSATKQIKTHGEPTTLYFNGNIRPKGYDIFTVGIGVNGDPGATPLEAEKFMQSISSKTENYTNVDDTNKIYDELNKYFKTIVEEKHSIVDGNVTDPMGEMIEFQLKNGQSFTHDDYVLVGNDGSQLKNGVALGGPNSDGGILKDVTVTYDKTSQTIKINHLNLGSGQKVVLTYDVRLKDNYISNKFYNTNNRTTLSPKSEKEPNTIRDFPIPKIRDVREFPVLTISNQKKMGEVEFIKVNKDKHSESLLGAKFQLQIEKDFSGYKQFVPEGSDVTTKNDGKIYFKALQDGNYKLYEISSPDGYIEVKTKPVVTFTIQNGEVTNLKADPNANKNQIGYLEGNGKHLITNT

SEQ ID NO: 13 - protein, 823 aa, Streptococcus agalactiae
GETQDTNQALGKVIVKKTGDNATPLGKATFVLKNDNDKSETSHETVEGSGEATFENIKPGDYTLREETAPIGYKKTDKTWKVKVADNGATIIEGMDADKAEKRKEVLNAQYPKSAIYEDTKENYPLVNVEGSKVGEQYKALNPINGKDGRREIAEGWLSKKITGVNDLDKNKYKIELTVEGKTTVETKELNQPLDVVVLLDNSNSMNNERANNSQRALKAGEAVEKLIDKITSNKDNRVALVTYASTIFDGTEATVSKGVADQNGKALNDSVSWDYHKTTFTATTHNYSYLNLTNDANEVNILKSRIPKEAEHINGDRTLYQFGATFTQKALMKANEILETQSSNARKKLIFHVTDGVPTMSYAINFNPYISTSYQNQFNSFLNKIPDRSGILQEDFIINGDDYQIVKGDGESFKLFSDRKVPVTGGTTQAAYRVPQNQLSVMSNEGYAINSGYIYLYWRDYNWVYPFDPKTKKVSATKQIKTHGEPTTLYFNGNIRPKGYDIFTVGIGVNGDPGATPLEAEKFMQSISSKTENYTNVDDTNKIYDELNKYFKTIVEEKHSIVDGNVTDPMGEMIEFQLKNGQSFTHDDYVLVGNDGSQLKNGVALGGPNSDGGILKDVTVTYDKTSQTIKINHLNLGSGQKVVLTYDVRLKDNYISNKFYNTNNRTTLSPKSEKEPNTIRDFPIPKIRDVREFPVLTISNQKKMGEVEFIKVNKDKHSESLLGAKFQLQIEKDFSGYKQFVPEGSDVTTKNDGKIYFKALQDGNYKLYEISSPDGYIEVKTKPVVTFTIQNGEVTNLKADPNANKNQIGYLEGNGKHLITNT

SEQ ID NO: 14 - protein, 1109 aa, Streptococcus agalactiae
QSDIKANTVTEDTPATEQAVEPPQPIAVSEESRSSKETKTSQTPSDVGETVADDANDLAPQAPAKTADTPATSKATIRDLNDPSHVKTLQEKAGKGAGTVVAVIDAGFDKNHEAWRLTDKTKARYQSKENLEKAKKEHGITYGEWVNDKVAYYHDYSKDGKNAVDQEHGTHVSGILSGNAPSEMKEPYRLEGAMPEAQLLLMRVEIVNGLADYARNYAQAIRDAVNLGAKVINMSFGNAALAYANLPDETKKAFDYAKSKGVSIVTSAGNDSSFGGKPRLPLADHPDYGVVGTPAAADSTLTVASYSPDKQLTETATVKTDDHQDKEMPVISTNRFEPNKAYDYAYANRGTKEDDFKDVEGKIALIERGDIDFKDKIANAKKAGAVGVLIYDNQDKGFPIELPNVDQMPAAFISRRDGLLLKDNPPKTITFNATPKVLPTASGTKLSRFSSWGLTADGNIKPDIAAPGQDILSSVANNKYAKLSGTSMSAPLVAGIMGLLQKQYETQYPDMTPSERLDLAKKVLMSSATALYDEDEKAYFSPRQQGAGAVDAKKASAATMYVTDKDNTSSKVHLNNVSDKFEVTVTVHNKSDKPQELYYQVTVQTDKVDGKHFALAPKALYETSWQKITIPANSSKQVTVPIDASRFSKDLLAQMKNGYFLEGFVRFKQDPTKEELMSIPYIGFRGDFGNLSALEKPIYDSKDGSSYYHEANSDAKDQLDGDGLQFYALKNNFTALTTESNPWTIIKAVKEGVENIEDIESSEITETIFAGTFAKQDDDSHYYIHRHANGKPYAAISPNGDGNRDYVQFQGTFLRNAKNLVAEVLDKEGNVVWTSEVTEQVVKNYNNDLASTLGSTRFEKTRWDGKDKDGKVVANGTYTYRVRYTPISSGAKEQHTDFDVIVDNTTPEVATSATFSTEDSRLTLASKPKTSQPVYRERIAYTYMDEDLPTTEYISPNEDGTFTLPEEAETMEGATVPLKMSDFTYVVEDMAGNITYTPVTKLLEGHSNKPEQDGSDQAPDKKPEAKPEQDGSGQTPDKKKETKPEKDSSGQTPGKTPQKGQSSRTLEKRSSKRALATKASTRDQLPTTNDKDTNRLHLLKLVMTTFFLG

SEQ ID NO: 15 - protein, 1103 aa, Streptococcus agalactiae
MRKKQKLPFDKLAIALISTSILLNAQSDIKANTVTEDTPATEQAVEPPQPIAVSEESRSSKETKTSQTPSDVGETVADDANDLAPQAPAKTADTPATSKATIRDLNDPSHVKTLQEKAGKGAGTVVAVIDAGFDKNHEAWRLTDKTKARYQSKENLEKAKKEHGITYGEWVNDKVAYYHDYSKDGKNAVDQEHGTHVSGILSGNAPSEMKEPYRLEGAMPEAQLLLMRVEIVNGLADYARNYAQAIRDAVNLGAKVINMSFGNAALAYANLPDETKKAFDYAKSKGVSIVTSAGNDSSFGGKPRLPLADHPDYGVVGTPAAADSTLTVASYSPDKQLTETATVKTDDHQDKEMPVISTNRFEPNKAYDYAYANRGTKEDDFKDVEGKIALIERGDIDFKDKIANAKKAGAVGVLIYDNQDKGFPIELPNVDQMPAAFISRRDGLLLKDNPPKTITFNATPKVLPTASGTKLSRFSSWGLTADGNIKPDIAAPGQDILSSVANNKYAKLSGTSMSAPLVAGIMGLLQKQYETQYPDMTPSERLDLAKKVLMSSATALYDEDEKAYFSPRQQGAGAVDAKKASAATMYVTDKDNTSSKVHLNNVSDKFEVTVTVHNKSDKPQELYYQVTVQTDKVDGKHFALAPKALYETSWQKITIPANSSKQVTVPIDASRFSKDLLAQMKNGYFLEGFVRFKQDPTKEELMSIPYIGFRGDFGNLSALEKPIYDSKDGSSYYHEANSDAKDQLDGDGLQFYALKNNFTALTTESNPWTIIKAVKEGVENIEDIESSEITETIFAGTFAKQDDDSHYYIHRHANGKPYAAISPNGDGNRDYVQFQGTFLRNAKNLVAEVLDKEGNVVWTSEVTEQVVKNYNNDLASTLGSTRFEKTRWDGKDKDGKVVANGTYTYRVRYTPISSGAKEQHTDFDVIVDNTTPEVATSATFSTEDSRLTLASKPKTSQPVYRERIAYTYMDEDLPTTEYISPNEDGTFTLPEEAETMEGATVPLKMSDFTYVVEDMAGNITYTPVTKLLEGHSNKPEQDGSDQAPDKKPEAKPEQDGSGQTPDKKKETKPEKDSSGQTPGKTPQKGQSSRTLEKRSSKRALATK

SEQ ID NO: 16 - protein, 1078 aa, Streptococcus agalactiae
QSDIKANTVTEDTPATEQAVEPPQPIAVSEESRSSKETKTSQTPSDVGETVADDANDLAPQAPAKTADTPATSKATIRDLNDPSHVKTLQEKAGKGAGTVVAVIDAGFDKNHEAWRLTDKTKARYQSKENLEKAKKEHGITYGEWVNDKVAYYHDYSKDGKNAVDQEHGTHVSGILSGNAPSEMKEPYRLEGAMPEAQLLLMRVEIVNGLADYARNYAQAIRDAVNLGAKVINMSFGNAALAYANLPDETKKAFDYAKSKGVSIVTSAGNDSSFGGKPRLPLADHPDYGVVGTPAAADSTLTVASYSPDKQLTETATVKTDDHQDKEMPVISTNRFEPNKAYDYAYANRGTKEDDFKDVEGKIALIERGDIDFKDKIANAKKAGAVGVLIYDNQDKGFPIELPNVDQMPAAFISRRDGLLLKDNPPKTITFNATPKVLPTASGTKLSRFSSWGLTADGNIKPDIAAPGQDILSSVANNKYAKLSGTSMSAPLVAGIMGLLQKQYETQYPDMTPSERLDLAKKVLMSSATALYDEDEKAYFSPRQQGAGAVDAKKASAATMYVTDKDNTSSKVHLNNVSDKFEVTVTVHNKSDKPQELYYQVTVQTDKVDGKHFALAPKALYETSWQKITIPANSSKQVTVPIDASRFSKDLLAQMKNGYFLEGFVRFKQDPTKEELMSIPYIGFRGDFGNLSALEKPIYDSKDGSSYYHEANSDAKDQLDGDGLQFYALKNNFTALTTESNPWTIIKAVKEGVENIEDIESSEITETIFAGTFAKQDDDSHYYIHRHANGKPYAAISPNGDGNRDYVQFQGTFLRNAKNLVAEVLDKEGNVVWTSEVTEQVVKNYNNDLASTLGSTRFEKTRWDGKDKDGKVVANGTYTYRVRYTPISSGAKEQHTDFDVIVDNTTPEVATSATFSTEDSRLTLASKPKTSQPVYRERIAYTYMDEDLPTTEYISPNEDGTFTLPEEAETMEGATVPLKMSDFTYVVEDMAGNITYTPVTKLLEGHSNKPEQDGSDQAPDKKPEAKPEQDGSGQTPDKKKETKPEKDSSGQTPGKTPQKGQSSRTLEKRSSKRALATK

SEQ ID NO: 17 - protein, 392 aa, Streptococcus agalactiae
DLVKQDNKSSYTVKYGDTLSVISEAMSIDMNVLAKINNIADINLIYPETTLTVTYDQKSHTATSMKIETPATNAAGQTTATVDLKTNQVSVADQKVSLNTISEGMTPEAATTIVSPMKTYSSAPALKSKEVLAQEQAVSQAAANEQVSPAPVKSITSEVPAAKEEVKPTQTSVSQSTTVSPASVAAETPAPVAKVAPVRTVAAPRVASVKVVTPKVETGASPEHVSAPAVPVTTTSPATDSKLQATEVKSVPVAQKAPTATPVAQPASTTNAVAAHPENAGLQPHVAAYKEKVASTYGVNEFSTYRAGDPGDHGKGLAVDFIVGTNQALGNKVAQYSTQNMAANNISYVIWQQKFYSNTNSIYGPANTWNAMPDRGGVTANHYDHVHVSFNK

SEQ ID NO: 18 - protein, 869 aa, Streptococcus agalactiae
MRKYQKFSKILTLSLFCLSQIPLNTNVLGESTVPENGAKGKLVVKKTDDQNKPLSKATFVLKTTAHPESKIEKVTAELTGEATFDNLIPGDYTLSEETAPEGYKKTNQTWQVKVESNGKTTIQNSGDKNSTIGQNQEELDKQYPPTGIYEDTKESYKLEHVKGSVPNGKSEAKAVNPYSSEGEHIREIPEGTLSKRISEVGDLAHNKYKIELTVSGKTIVKPVDKQKPLDVVFVLDNSNSMNNDGPNFQRHNKAKKAAEALGTAVKDILGANSDNRVALVTYGSDIFDGRSVDVVKGFKEDDKYYGLQTKFTIQTENYSHKQLTNNAEEIIKRIPTEAPKAKWGSTTNGLTPEQQKEYYLSKVGETFTMKAFMEADDILSQVNRNSQKIIVHVTDGVPTRSYAINNFKLGASYESQFEQMKKNGYLNKSNFLLTDKPEDIKGNGESYFLFPLDSYQTQIISGNLQKLHYLDLNLNYPKGTIYRNGPVKEHGTPTKLYINSLKQKNYDIFNFGIDISGFRQVYNEEYKKNQDGTFQKLKEEAFKLSDGEITELMRSFSSKPEYYTPIVTSADTSNNEILSKIQQQFETILTKENSIVNGTIEDPMGDKINLQLGNGQTLQPSDYTLQGNDGSVMKDGIATGGPNNDGGILKGVKLEYIGNKLYVRGLNLGEGQKVTLTYDVKLDDSFISNKFYDTNGRTTLNPKSEDPNTLRDFPIPKIRDVREYPTITIKNEKKLGEIEFIKVDKDNNKLLLKGATFELQEFNEDYKLYLPIKNNNSKVVTGENGKISYKDLKDGKYQLIEAVSPEDYQKITNKPILTFEVVKGSIKNIIAVNKQISEYHEEGDKHLITNTHIPPKGIIPMTGGKGILS

SEQ ID NO: 19 - protein, 858 aa, Streptococcus agalactiae
MRKYQKFSKILTLSLFCLSQIPLNTNVLGESTVPENGAKGKLVVKKTDDQNKPLSKATFVLKTTAHPESKIEKVTAELTGEATFDNLIPGDYTLSEETAPEGYKKTNQTWQVKVESNGKTTIQNSGDKNSTIGQNQEELDKQYPPTGIYEDTKESYKLEHVKGSVPNGKSEAKAVNPYSSEGEHIREIPEGTLSKRISEVGDLAHNKYKIELTVSGKTIVKPVDKQKPLDVVFVLDNSNSMNNDGPNFQRHNKAKKAAEALGTAVKDILGANSDNRVALVTYGSDIFDGRSVDVVKGFKEDDKYYGLQTKFTIQTENYSHKQLTNNAEEIIKRIPTEAPKAKWGSTTNGLTPEQQKEYYLSKVGETFTMKAFMEADDILSQVNRNSQKIIVHVTDGVPTRSYAINNFKLGASYESQFEQMKKNGYLNKSNFLLTDKPEDIKGNGESYFLFPLDSYQTQIISGNLQKLHYLDLNLNYPKGTIYRNGPVKEHGTPTKLYINSLKQKNYDIFNFGIDISGFRQVYNEEYKKNQDGTFQKLKEEAFKLSDGEITELMRSFSSKPEYYTPIVTSADTSNNEILSKIQQQFETILTKENSIVNGTIEDPMGDKINLQLGNGQTLQPSDYTLQGNDGSVMKDGIATGGPNNDGGILKGVKLEYIGNKLYVRGLNLGEGQKVTLTYDVKLDDSFISNKFYDTNGRTTLNPKSEDPNTLRDFPIPKIRDVREYPTITIKNEKKLGEIEFIKVDKDNNKLLLKGATFELQEFNEDYKLYLPIKNNNSKVVTGENGKISYKDLKDGKYQLIEAVSPEDYQKITNKPILTFEVVKGSIKNIIAVNKQISEYHEEGDKHLITNTHIPPKGI

(19) United States
(12) Patent Application Publication
(10) Pub. No.: US 2010/0063270 A1
(43) Pub. Date: Mar. 11, 2010

(54) Purification of Streptococcal Capsular Polysaccharide

(76) Inventor: Paolo Costantino, Siena (IT)

Correspondence Address: NOVARTIS VACCINES AND DIAGNOSTICS INC., INTELLECTUAL PROPERTY- X100B, P.O. BOX 8097, Emeryville, CA, 94662-8097, US

(21) Appl. No.: 11/883,615

(22) PCT Filed: Feb. 1, 2006
(86) PCT No.: PCT/IB06/00626

§ 371 Date: May 12, 2008

(30) Foreign Application Priority Data
Feb. 1, 2005 (GB) 0502096.1

(51) Int. Cl. C08B 37/00

(52) U.S. Cl. 536/123.1

(57) ABSTRACT

A purification process for the capsular polysaccharide of S. agalactiae in which the saccharide is initially treated with an aqueous mixture of an alcohol and a calcium salt, followed by precipitation with a cationic detergent. The process can be completed in less than three days and has a yield of around 60%. It avoids the need for DNase, RNase and/or protease treatment. The saccharides of the process have a very low protein contamination and a very low absorbance at 280 nm.

All documents cited herein are incorporated by reference in their entirety.

### TECHNICAL FIELD

This invention is in the field of purifying bacterial capsular polysaccharides, particularly those of Streptococcus agalactiae, and particularly for use in the preparation of vaccines.

### BACKGROUND ART

The capsular saccharides of bacteria have been used for many years in vaccines against capsulated bacteria. As saccharides are T-independent antigens, however, they are poorly immunogenic. Conjugation to a carrier can convert T-independent antigens into T-dependent antigens, thereby enhancing memory responses and allowing protective immunity to develop. The most effective saccharide vaccines are therefore based on glycoconjugates, and the prototype conjugate vaccine was against Haemophilus influenzae type b (‘Hib’) [e.g. see chapter 14 of ref. 79].

Another bacterium for which conjugate vaccines have been described is Streptococcus agalactiae, also known as ‘group B streptococcus’, or simply as ‘GBS’. Much of this work has been performed by Dennis Kasper and colleagues, and is described in documents such as references 1 to 9.

The starting point for saccharide-based vaccines is the saccharide itself, and this is generally purified from the target bacterium. The Kasper process for purification of the GBS saccharide is described in detail in references 2 and 10, and involves the following basic steps after bacterial culture: filtration to remove bacteria; ultrafiltration with a 10 kDa cut-off membrane; addition of ethanol to 30% to precipitate contaminants; increase ethanol to 80% to precipitate the GBS saccharide overnight; collect and dry the precipitate; treat with RNase, then DNase, then pronase; treatment with sodium hydroxide; dialysis; DEAE-Sephacel ion-exchange chromatography; dialysis; lyophilisation; acetic anhydride treatment; conconavilin affinity chromatography to remove mannan; Ultragel size exclusion chromatography; and final lyophilisation.

This process is very slow, with the RNase, DNase, pronase and sodium hydroxide treatments each lasting overnight, and can take well over a week to complete. Furthermore, the yield is well below 50%. There is thus a need for further and improved processes for purifying GBS capsular polysaccharides, and particularly for quicker processes with higher yields.

### DISCLOSURE OF THE INVENTION

The invention is based on a purification process in which the saccharide is initially treated with an aqueous mixture of an alcohol (e.g. ethanol) and a metal cation (e.g. as a calcium salt), followed by precipitation with a cationic detergent (e.g. CTAB). The process can be completed in less than three days after release of saccharide from the bacteria and has a yield of around 60%.

The invention provides a process for purifying a Streptococcus agalactiae capsular polysaccharide, comprising the steps of: (a) treating a suspension comprising streptococcal proteins, nucleic acids and capsular polysaccharide with an aqueous metal cation and an alcohol in order to precipitate nucleic acids and proteins; (b) separating the precipitated material from the aqueous material; and (c) treating the aqueous material with a cationic detergent in order to precipitate the capsular polysaccharide. The precipitated polysaccharide can then be separated and re-solubilised for subsequent vaccine preparation. Other processing steps may be included in the process, such as ultrafiltration to remove low molecular weight contaminants (such as fragments of group-specific carbohydrate), further precipitation and re-solubilisation, and/or drying steps.

The invention also provides a process for purifying a Streptococcus agalactiae capsular polysaccharide, comprising the step of precipitating the saccharide using a cationic detergent. Similarly, the invention provides, in a process for purifying the Streptococcus agalactiae capsular polysaccharide, the improvement consisting of the use of a cationic detergent to precipitate the saccharide. Precipitation with a cationic detergent simplifies separation of the capsular saccharide from other saccharides that are present e.g. the group-specific saccharide.

The invention also provides a process for purifying a Streptococcus agalactiae capsular polysaccharide, comprising the step of removing contaminating nucleic acids and/or proteins by the use of precipitation. Similarly, the invention provides, in a process for purifying the Streptococcus agalactiae capsular polysaccharide, the improvement consisting of the use of precipitation to remove contaminating nucleic acids. Precipitation avoids the need for DNase or RNase enzymatic treatments.

The invention also provides a process for purifying the Streptococcus agalactiae capsular polysaccharide, wherein the process does not involve a step of DNase treatment. Similarly, the invention provides a process for purifying the Streptococcus agalactiae capsular polysaccharide, wherein the process does not involve a step of RNase treatment. Similarly, the invention provides a process for purifying the Streptococcus agalactiae capsular polysaccharide, wherein the process does not involve a step of protease treatment. Preferably, the process of the invention does not involve the use of two or three of DNase, RNase and/or protease e.g. it uses none of the three.

The invention also provides a process for purifying capsular saccharide from Streptococcus agalactiae bacteria, wherein the yield of the process (starting with the bacteria and ending with the capsular polysaccharide) is at least 40% (e.g. >50%, >60%, >70%, >80%, >90%). Practical limitations mean that the yield might not exceed 90% (e.g. might be <90%, <80%, <70%, etc.).

The invention also provides a process for purifying capsular saccharide from Streptococcus agalactiae bacteria, wherein the process provides a composition comprising the saccharide in which purity of the saccharide is at least 89% (e.g. ≧90%, ≧92%, ≧94%, ≧96%, ≧98%, etc.) relative to the total weight of saccharide, protein and nucleic acid in the composition.

The invention also provides a process for purifying capsular saccharide from Streptococcus agalactiae bacteria, wherein (a) the yield of the process is at least 40% (as described above) and (b) the purity of the saccharide is at least 89% (as described above).

The invention also provides a process for releasing the capsular polysaccharide from Streptococcus agalactiae bacteria, comprising the step of treating the bacteria with a type II phosphodiesterase. These enzymes can cleave the same phosphates as sodium hydroxide, but offer the advantage of not having sodium hydroxide's de-acetylating reactivity.

The invention also provides a composition comprising a Streptococcus agalactiae capsular polysaccharide, wherein UV absorbance at 280 nm is less than 0.20. An absorbance of <0.15 or even <0.10 is preferred. The processes of the invention have been found to give compositions with very little protein contamination, leading to very little absorbance at 280 nm. This is a particular advantage over the methods of the prior art, which give material that shows an absorbance peak at ˜280 nm.

The invention also provides a composition comprising a Streptococcus agalactiae capsular polysaccharide, wherein the ratio of UV absorbance at 280 nm to the UV absorbance at 260 nm is greater than 0.85. A ratio of >0.90, >0.95 or even >1.0 is preferred. The ratio will typically be less than 1.2. A ratio of 1.0±0.1 is preferred.

The invention also provides a composition comprising a Streptococcus agalactiae capsular polysaccharide, wherein the UV absorbance spectrum of the composition between 220 nm and 300 nm does exhibit either a shoulder or peak at around 270 nm. The invention also provides a composition comprising a Streptococcus agalactiae serotype Ia or serotype III capsular polysaccharide, wherein the UV absorbance spectrum between 250 nm and 275 nm does not increase. The invention also provides a composition comprising a Streptococcus agalactiae capsular polysaccharide, wherein the UV spectrum of the composition between 250 nm and 275 nm has neither a maximum point nor a point of inflexion.

The invention also provides a composition comprising Streptococcus agalactiae capsular saccharide, wherein the purity of the saccharide is at least 89% (e.g. ≧90%, ≧92%, ≧94%, ≧96%, ≧98%, etc.) relative to the total weight of saccharide, protein and nucleic acid in the composition.

The invention also provides a composition comprising Streptococcus agalactiae serotype Ia capsular saccharide, wherein the saccharide has monosaccharide subunits, and wherein no more than 93% (e.g. ≦92%, ≦90%, ≦85%, ≦80%, ≦75%, ≦70%, ≦65%, ≦60%, ≦55%, ≦50%, ≦45%, ≦40%, etc.) of the monosaccharide subunits have N-acetyl groups.

The invention also provides a composition comprising Streptococcus agalactiae serotype Ib capsular saccharide, wherein the saccharide has monosaccharide subunits, and wherein at least 78% (e.g. ≧80%, ≧85%, ≧90%, ≧92%, ≧94%, ≧96%, ≧98%, etc.) of the monosaccharide subunits have N-acetyl groups.

The invention also provides a composition comprising Streptococcus agalactiae serotype III capsular saccharide, wherein the saccharide has monosaccharide subunits, and wherein no more than 76% (e.g. ≦74%, ≦72%, ≦70%, ≦65%, ≦60%, ≦55%, ≦50%, ≦45%, ≦40%, etc.) of the monosaccharide subunits have N-acetyl groups.

The invention also provides a composition comprising Streptococcus agalactiae serotype Ia capsular saccharide, wherein the saccharide has a molecular weight of at least 100 kDa.

The invention also provides a composition comprising Streptococcus agalactiae serotype Ib capsular saccharide, wherein the saccharide has a molecular weight of at least 40 kDa.

The invention also provides a composition comprising Streptococcus agalactiae serotype III capsular saccharide, wherein the saccharide has a molecular weight of at least 40 kDa.

### The Capsular Saccharide

The S. agalactiae capsular polysaccharide is covalently linked to GlcNAc residues in the bacterium's peptidoglycan backbone, and is distinct from the group B antigen, which is separate saccharide that is attached to MurNAc residues on the same peptidoglycan backbone (FIG. 1 [12]). The capsular polysaccharides of different serotypes are chemically related, but are antigenically very different. All GBS capsular polysaccharides share the following trisaccharide core:

β-D-GlcpNAc(1→3)β-D-Galp(1→4)β-D-Glcp

The various GBS serotypes differ by the way in which this core is modified. The difference between serotypes Ia and III, for instance, arises from the use of either the GlcNAc (Ia) or the Gal (III) in this core for linking consecutive trisaccharide cores (FIG. 3). Serotypes Ia and Ib both have a [α-D-NeupNAc(2→3)β-D-Galp-(1→] disaccharide linked to the GlcNAc in the core, but the linkage is either 1→4 (Ia) or 1→3 (Ib).

GBS-related disease arises primarily from serotypes Ia, Ib, II, III, IV, V, VI, VII, and VIII, with over 90% being caused by five serotypes: Ia, Ib, II, III & V. The invention preferably uses a saccharide from one of these five serotypes. As shown in FIG. 2, the capsular saccharides of each of these five serotypes include: (a) a terminal N-acetyl-neuraminic acid (NeuNAc) residue (commonly referred to as sialic acid), which in all cases is linked 2→3 to a galactose residue; and (b) a N-acetyl-glucosamine residue (GlcNAc) within the trisaccharide core.

All five saccharides include galactose residues within the trisaccharide core, but serotypes Ia, Ib, II & III also contain additional galactose residues in each repeating unit, with the serotype II saccharide containing three galactose residues per repeating unit. Saccharides purified according to the invention will generally be in their native form, but they may have been modified. For example, the saccharide may be shorter than the native capsular saccharide, or may be chemically modified.

Thus the saccharide used according to the invention may be a substantially full-length capsular polysaccharide, as found in nature, or it may be shorter than the natural length. Full-length polysaccharides may be depolymerised to give shorter fragments for use with the invention e.g. by hydrolysis in mild acid, by heating, by sizing chromatography, etc. Chain length has been reported to affect immunogenicity of GBS saccharides in rabbits [4].

Depolymerisation of the serotype III capsular saccharide by endo-β-galactosidase has been reported [refs. 1 & 4-6]. Ozonolysis of capsular polysaccharides from GBS serotypes II, III and VIII has also been used for depolymerisation [13]. It is preferred to use saccharides with MW>30 kDa, and substantially full-length capsular polysaccharides can be used. For serotype Ia, it is preferred to use polysaccharides with a MW up to ˜145 kDa. For serotype Ib, it is preferred to use polysaccharides with a MW up to ˜50 kDa. For serotype III, it is preferred to use polysaccharides with a MW up to ˜50 kDa. These molecular masses can be measured by gel filtration relative to dextran standards, such as those available from Polymer Standard Service [14].

The saccharide may be chemically modified relative to the capsular saccharide as found in nature. For example, the saccharide may be de-O-acetylated (partially or fully), de-N-acetylated (partially or fully), N-propionated (partially or fully), etc. Depending on the particular saccharide, de-acetylation may or may not affect immunogenicity e.g. the NeisVac-C™ vaccine uses a de-O-acetylated saccharide, whereas Menjugate™ is acetylated, but both vaccines are effective. The relevance of O-acetylation on GBS saccharides in various serotypes is discussed in reference 15, and it is preferred to retain O-acetylation of sialic acid residues at positions 7, 8 and/or 9 before during and after purification e.g. by using formaldehyde for extraction of the saccharide and/or bacterial inactivation, by protection/de-protection, by re-acetylation, etc. The effect of de-acetylation etc. can be assessed by routine assays.

### Starting Material

The process of the invention starts with the capsular saccharide in aqueous form, typically as a suspension comprising streptococcal proteins, nucleic acids and capsular polysaccharide.

A small amount of capsular polysaccharide is released into the culture medium during bacterial growth, and so the starting material for alcoholic precipitation of contaminating proteins and/or nucleic acids may thus be the supernatant from a centrifuged bacterial culture. More typically, however, the starting material will be prepared by treating the capsulated bacteria themselves (or Material containing the bacterial peptidoglycan), such that the capsular saccharide is released. Reference 10 characterises saccharides prepared from both of these two sources.

Capsular polysaccharide can be released from bacteria by various methods, including chemical, physical or enzymatic treatment. Thus an aqueous preparation of polysaccharide can be treated prior to the initial protein/nucleic acid precipitation reaction.

A typical chemical treatment is base extraction [16] (e.g. using sodium hydroxide), which can cleave the phosphodiester linkage between the capsular saccharide and the peptidoglycan backbone. Base extraction is advantageous because it inactivates the bacteria at the same time as releasing the capsular polysaccharide. Moreover, base treatment releases the polysaccharide intact and causes extensive cleavage of the group B antigen due to its multiple phosphodiester linkages (FIG. 4 [12]), facilitating later separation of the capsular and group-specific saccharide antigens. Sodium hydroxide treatment is therefore a preferred method for releasing the capsular polysaccharide. As hydroxide treatment de-N-acetylates the capsular saccharide, however, later re-N-acetylation may be necessary.

A typical enzymatic treatment involves the use of both mutanolysin and β-N-acetylglucosaminidase [12]. These act on the GBS peptidoglycan to release the capsular saccharide for use with the invention, but also lead to release of the group-specific carbohydrate antigen. An alternative enzymatic treatment involves treatment with a type II phosphodiesterase (PDE2). PDE2 enzymes can cleave the same phosphates as sodium hydroxide (see above) and can release the capsular saccharide without cleaving the group-specific carbohydrate antigen and without de-N-acetylating the capsular saccharide, thereby simplifying downstream steps. PDE2 enzymes are therefore a preferred option for preparing GBS capsular saccharides for use in the processes of the invention.

A preferred starting material for the process of the invention is thus de-N-acetylated capsular polysaccharide, which can be obtained by base extraction as described in reference 16. Another preferred starting material is thus the product of PDE2 treatment of GBS. Such materials can be subjected to concentration (e.g. ultrafiltration) prior to precipitation by the processes of the invention.

### Alcoholic Precipitation and Cation Exchange

The GBS capsular saccharide obtained after culture will generally be impure and will be contaminated with bacterial nucleic acids and proteins. The prior art removes these contaminants by sequential overnight treatments with RNase, DNase and protease. In contrast, the overall purification process of the invention can be performed in a shorter time than these three individual steps from the prior art process. Rather than remove these contaminants enzymatically, the process of the invention utilises alcoholic precipitation. If necessary (e.g. after base extraction), materials will usually be neutralised prior to the precipitation.

The alcohol used to precipitate contaminating nucleic acids and/or proteins is preferably a lower alcohol, such as methanol, ethanol, propan-1-ol, propan-2-ol, butan-1-ol, butan-2-ol, 2-methyl-propan-1-ol, 2-methyl-propan-2-ol, diols, etc. The selection of an appropriate alcohol can be tested empirically, without undue burden, but alcohols such as ethanol and isopropanol (propan-2-ol) are preferred, rather than alcohols such as phenol.

The alcohol is preferably added to the polysaccharide suspension to give a final alcohol concentration of between 10% and 50% (e.g. around 30%). The most useful concentrations are those which achieve adequate precipitation of contaminants without also precipitating the polysaccharide. The optimum final alcohol concentration may depend on the GBS serotype from which the polysaccharide is obtained, and can be determined by routine experiments without undue burden. Precipitation of polysaccharides as ethanol concentrations >50% has been observed.

The alcohol may be added in pure form or may be added in a form diluted with a miscible solvent (e.g. water). Preferred solvent mixtures are ethanol:water mixtures, with a preferred ratio of between around 70:30 and around 95:5 (e.g. 75:25, 80:20, 85:15, 90:10).

The saccharide is also treated with an aqueous metal cation. Monovalent and divalent metal cations are preferred, and divalent cations are particularly preferred, such as Mg⁺⁺, Mn⁺⁺, Ca⁺⁺, etc, as they are more efficient at complex formation. Calcium ions are particularly useful, and so the alcohol mixture preferably includes soluble calcium ions. These may be added to a saccharide/alcohol mixture in the form of calcium salts, either added as a solid or in an aqueous form. The calcium ions are preferably provided by the use of calcium chloride.

The calcium ions are preferably present at a final concentration of between 10 and 500 mM e.g. about 0.1 M. The optimum final Ca⁺⁺ concentration may depend on the GBS serotype from which the polysaccharide is obtained, and can be determined by routine experiments without undue burden.

The alcohol and the cation play different roles (the alcohol is used to precipitate contaminants, whereas the cation stabilises and complexes the saccharide in soluble form) but produce a combined effect. Although the aim is to prepare a mixture of the saccharide, the alcohol and the cation, these three components need not be mixed together simultaneously. Thus the alcohol and cation can be used sequentially or simultaneously. Sequential treatment is preferred, and a particularly preferred process involves addition of the cation to the saccharide followed by addition of the alcohol to the cation/saccharide mixture, although the alcohol can be used before the cation if desired.

After alcoholic precipitation of contaminating proteins and/or nucleic acids, the GBS capsular polysaccharide is left in solution. The precipitated material can be separated from the polysaccharide by any suitable means, such as by centrifugation. The supernatant can be subjected to microfiltration, and in particular to dead-end filtration (perpendicular filtration) in order to remove particles that may clog filters in later steps (e.g. precipitated particles with a diameter greater than 0.22 μm). As an alternative to dead-end filtration, tangential microfiltration can be used.

### Diafiltration

The process of the invention may involve a step of diafiltration after the precipitation of proteins and/or nucleic acids, and before the detergent-mediated precipitation. This diafiltration step is particularly advantageous if base extraction or phosphodiesterase was used for release of the capsular saccharide, as the group-specific saccharide will also have been hydrolysed, to give fragments much smaller than the intact capsular saccharide. These small fragments can be removed by the diafiltration step.

Tangential flow diafiltration is typical. The filtration membrane should thus be one that allows passage of hydrolysis products of the group-specific antigen while retaining the capsular polysaccharide. A cut-off in the range 10 kDa-30 kDa is typical. Smaller cut-off sizes can be used, as the hydrolysis fragments of the group-specific antigen are generally around 1 kDa (5-mer, 8-mer and 11-mer saccharides), but the higher cut-off advantageously allows removal of other contaminants without leading to loss of the capsular saccharide.

At least 5 cycles of tangential flow diafiltration are usually performed e.g. 6, 7, 8, 9, 10, 11 or more.

### Cationic Detergent Treatment

Many techniques for precipitating soluble polysaccharides are known in the art. According to the invention, the GBS saccharide is precipitated using one or more cationic detergents. The inventors have found that treating a mixture of the GBS capsular saccharide and group-specific saccharide with a cationic detergent leads to preferential precipitation of the capsular saccharide, thereby advantageously and conveniently minimising contamination by the group-specific saccharide.

The cationic detergent preferably has the following general formula:

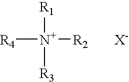

wherein:
R₁, R₂ and R₃ are the same or different and each signifies alkyl or aryl; or R₁ and R₂ together with the nitrogen atom to which they are attached form a 5- or 6-membered saturated heterocyclic ring, and R₃ signifies alkyl or aryl; or R₁, R₂ and R₃ together with the nitrogen atom to which they are attached form a 5- or 6-membered heterocyclic ring, unsaturated at the nitrogen atom,
R₄ signifies alkyl or aryl, and
X⁻ signifies an anion.

Particularly preferred detergents for use in the process of the invention are tetrabutylammonium and cetyltrimethylammonium salts (e.g. the bromide salts). Cetyltrimethylammonium bromide (‘CTAB’) is particularly preferred [17]. CTAB is also known as hexadecyltrimethylammonium bromide, cetrimonium bromide, Cetavlon and Centimide. Other detergents include hexadimethrine bromide and myristyltrimethylammonium salts.

The detergent-mediated precipitation step is preferably selective for the capsular polysaccharide. Advantageously, the invention uses a detergent such as CTAB that interacts with sialic acid residues in the saccharide e.g. via carboxyl groups in the sialic acid. The detergent will thus preferentially precipitate the sialic acid-containing capsular saccharides, and particularly longer saccharides within a mixed population, thus minimising contamination by saccharides whose antigenically-important sialic acids may have been damaged in earlier treatment steps. For GBS, longer saccharides tend to be more immunogenic than shorter ones [18], and so the invention offers advantages over prior art methods which led to shorter depolymerised saccharides.

After precipitation, the capsular saccharides can be separated by centrifugation. The inventors have found that centrifugation after CTAB-mediated precipitation does not give a simple pellet, but instead gives a pellet that appears to have two phases. The bottom of these is typically chosen for further use with the invention.

### Re-Solubilisation

After precipitation, the polysaccharide (typically in the form of a complex with the cationic detergent) can be re-solubilised, either in aqueous medium or in alcoholic medium. For aqueous re-solubilisation, the CTA⁻ cation in the precipitate will generally be replaced by a metal cation; for alcoholic re-solubilisation, the CTA⁻ cation will generally be retained. The choice of aqueous or alcoholic re-solubilisation may depend on the GBS serotype from which the polysaccharide is obtained, and on any contaminants still present at this stage. For example, pigments are sometimes present in the precipitated pellet, and these can effectively be removed by alcoholic re-solubilisation followed by carbon filtration.

A typical aqueous medium for re-solubilisation will include a metal cation. Monovalent and divalent metal cations are preferred, and divalent cations are particularly preferred, such as Mg⁺⁺, Mn⁺⁺, Ca⁺⁺, etc. Calcium ions are particularly useful, and so re-solubilisation preferably uses Ca⁺⁺, provided provided by the use of calcium chloride. A Ca⁺⁺ concentration of between 10 and 500 mM (e.g. about 0.1M) is preferred. The optimum final Ca⁺⁺ concentration may depend on the GBS serotype from which the polysaccharide is obtained, and can be determined by routine experiments without undue burden.

A typical alcoholic medium for re-solubilisation is based on ethanol. The same alcohols used for precipitation of nucleic acids and/or proteins can be used, but the concentration required for precipitation of the capsular saccharide will generally be higher e.g. the alcohol is preferably added to give a final alcohol concentration of between 70% and 95% (e.g. around 70%, 75%, 80%, 85%, 90% or 95%). The optimum final alcohol concentration may depend on the GBS serotype from which the polysaccharide is obtained. To achieve the high alcohol concentrations then it is preferred to add alcohol with a low water content e.g. 96% ethanol.

Re-solubilisation will typically occur at room temperature. Acidic conditions are preferably avoided, and re-solubilisation will typically take place at about pH 7.

The re-solubilised material is highly purified relative to the pre-precipitation suspension.

### Further Treatment of the Capsular Polysaccharide

After re-solubilisation, the polysaccharide may be further treated to remove contaminants. This is particularly important in situations where even minor contamination is not acceptable (e.g. for human vaccine production).

One preferred further step is a further precipitation. Where an aqueous re-solubilisation was performed then this precipitation will typically use an alcohol, as described in the preceding section; conversely, where an alcoholic re-solubilisation was performed then this precipitation will typically use an aqueous cation solution, as described in the preceding section. The precipitated saccharide can then be separated from any remaining aqueous contaminants e.g. by centrifugation. The precipitated material is stable and can be stored for future use.

The precipitated material may be subjected to vacuum drying. This treatment will typically be used not to stabilise the saccharide for storage, but to dry the saccharide and remove any residual alcohol.

Further rounds of precipitation and filtration can also be performed. Depth filtration can also be used e.g. as an alternative to centrifugation. Depth filtration will typically be used after solubilisation in alcohol.

The polysaccharide may be depolymerised to form oligosaccharides. Oligosaccharides may be preferred to polysaccharides for use in vaccines, and chain length has been reported to affect immunogenicity of GBS saccharides in rabbits [4]. Depolymerisation from polysaccharide to oligosaccharide can occur before or after the detergent-mediated precipitation. If depolymerisation is performed, the products will generally be sized in order to remove short-length oligosaccharides. This can be achieved in various ways, such as ultrafiltration followed by ion-exchange chromatography. Where the composition of the invention includes a depolymerised saccharide, it is preferred that depolymerisation precedes any conjugation.

If sialic acid residues in the GBS capsular saccharides have been de-N-acetylated then the processes of the invention may include a step of re-N-acetylation. Controlled re-N-acetylation can conveniently be performed using a reagent such as acetic anhydride (CH₃CO)₂O e.g. in 5% ammonium bicarbonate [10].

These additional steps can generally be performed at room temperature.

### Conjugation

The final purified capsular polysaccharide of the invention can be used as an antigen without further modification e.g. for use in in vitro diagnostic assays, for use in immunisation, etc.

For immunisation purposes, however, it is preferred to conjugate the saccharide to a carrier molecule, such as a protein. In general, covalent conjugation of saccharides to carriers enhances the immunogenicity of saccharides as it converts them from T-independent antigens to T-dependent antigens, thus allowing priming for immunological memory. Conjugation is particularly useful for paediatric vaccines [e.g. ref. 19] and is a well known technique [e.g. reviewed in refs. 20 to 28]. Thus the processes of the invention may include the further step of conjugating the purified saccharide to a carrier molecule.

Conjugation of GBS saccharides has been widely reported e.g. see references 1 to 9. The typical prior art process for GBS saccharide conjugation typically involves reductive amination of a purified saccharide to a carrier protein such as tetanus toxoid (TT) or CRM197 [2]. The reductive amination involves an amine group on the side chain of an amino acid in the carrier and an aldehyde group in the saccharide. As GBS capsular saccharides do not include an aldehyde group in their natural form then this is generated before conjugation by periodate oxidation of a portion (e.g. between 5 and 15%, preferably about 10%) of the saccharide's sialic acid residues [2, 29]. Conjugate vaccines prepared in this manner have been shown to be safe and immunogenic in humans for each of GBS serotypes Ia, Ib, II, III, and V [30]. An alternative conjugation process involves the use of —NH₂ groups in the saccharide (either from de-N-acetylation, or after introduction of amines) in conjunction with bifunctional linkers, as described in ref. 31.

Preferred carrier proteins are bacterial toxins or toxoids, such as diphtheria toxoid or tetanus toxoid. The CRM197 mutant of diphtheria toxin [32-34] is a particularly preferred carrier for, as is a diphtheria toxoid. Other suitable carrier proteins include the N. meningitidis outer membrane protein [35], synthetic peptides [36, 37], heat shock proteins [38, 39], pertussis proteins [40, 41], cytokines [42], lymphokines [42], hormones [42], growth factors [42], human serum albumin (preferably recombinant), artificial proteins comprising multiple human CD4⁺ T cell epitopes from various pathogen-derived antigens [43] such as N19 [44], protein D from H. influenzae [45, 46], pneumococcal surface protein PspA [47], pneumolysin [48], iron-uptake proteins [49], toxin A or B from C. difficile [50], a GBS protein [109], etc.

Attachment to the carrier is preferably via a —NH₂ group e.g. in the side chain of a lysine residue in a carrier protein, or of an arginine residue. Attachment may also be via a —SH group e.g. in the side chain of a cysteine residue.

It is possible to use more than one carrier protein e.g. to reduce the risk of carrier suppression. Thus different carrier proteins can be used for different GBS serotypes e.g. serotype Ia saccharides might be conjugated to CRM197 while serotype Ib saccharides might be conjugated to tetanus toxoid. It is also possible to use more than one carrier protein for a particular saccharide antigen e.g. serotype III saccharides might be in two groups, with some conjugated to CRM197 and others conjugated to tetanus toxoid. In general, however, it is preferred to use the same carrier protein for all saccharides.

A single carrier protein might carry more than one saccharide antigen [51, 52]. For example, a single carrier protein might have conjugated to it saccharides from serotypes Ia and Ib. To achieve this goal, different saccharides can be mixed prior to the conjugation reaction. In general, however, it is preferred to have separate conjugates for each serogroup, with the different saccharides being mixed after conjugation. The separate conjugates may be based on the same carrier.

Conjugates with a saccharide:protein ratio (w/w) of between 1:5 (i.e. excess protein) and 5:1 (i.e. excess saccharide) are preferred. Ratios between 1:2 and 5:1 are preferred, as are ratios between 1:1.25 and 1:2.5.

Conjugates may be used in conjunction with free carrier [53]. When a given carrier protein is present in both free and conjugated form in a composition of the invention, the unconjugated form is preferably no more than 5% of the total amount of the carrier protein in the composition as a whole, and more preferably present at less than 2% by weight.

After conjugation, free and conjugated saccharides can be separated. There are many suitable methods, including hydrophobic chromatography, tangential ultrafiltration, diafiltration etc. [see also refs. 54 & 55, etc.].

In general, two types of conjugate can be made, as shown in FIG. 5: (a) a conjugate where an individual saccharide is attached to a single carrier e.g. through its reducing terminus; and (b) a conjugate where an individual saccharide is attached to multiple carriers e.g. because several monosaccharide subunits are reactive. In both situations a single carrier protein can link to multiple saccharide molecules because it can have multiple exposed lysine side chains. Conjugates of type (b) are more typical in the present invention, because the modified sialic acid or galactose residues of the invention occur at multiple sites along a single saccharide [56]. In preferred conjugates, therefore, a single saccharide molecule is coupled on average to more than one carrier molecule.

### Combinations of Conjugates and Other Antigens

Saccharides prepared by the methods of the invention (in particular after conjugation as described above) can be mixed e.g. with each other and/or with other antigens. Thus the processes of the invention may include the further step of mixing the saccharide with one or more further antigens.

Where multiple different GBS conjugates are mixed then these may include different types of conjugate from the same GBS serotype and/or conjugates from different GBS serotypes. For example, the conjugates may be from two or three of serotypes Ia, Ib and III. The composition will be produced by preparing separate conjugates (e.g. a different conjugate for each serotype) and then combining the conjugates.

The further antigen(s) may comprise GBS amino acid sequences, as set out below.

The further antigen(s) may comprise antigens from non-GBS pathogens. Thus the compositions of the invention may further comprise one or more non-GBS antigens, including additional bacterial, viral or parasitic antigens. These may be selected from the following:
a protein antigen from N. meningitidis serogroup B, such as those in refs. 57 to 63, with protein ‘287’ (see below) and derivatives (e.g. ‘ΔG287’) being particularly preferred.
an outer-membrane vesicle (OMV) preparation from N. meningitidis serogroup B, such as those disclosed in refs. 64, 65, 66, 67 etc.
a saccharide antigen from N. meningitidis serogroup A, C, W135 and/or Y, such as the oligosaccharide disclosed in ref. 68 from serogroup C or the oligosaccharides of ref. 69.
a saccharide antigen from Streptococcus pneumoniae [e.g. refs. 70-72; chapters 22 & 23 of ref. 79].
an antigen from hepatitis A virus, such as inactivated virus [e.g. 73, 74; chapter 15 of ref. 79].
an antigen from hepatitis B virus, such as the surface and/or core antigens [e.g. 74, 75; chapter 16 of ref. 79].
an antigen from hepatitis C virus [e.g. 76].
an antigen from Bordetella pertussis, such as pertussis holotoxin (PT) and filamentous haemagglutinin (FHA) from B. pertussis, optionally also in combination with pertactin and/or agglutinogens 2 and 3 [e.g. refs. 77 & 78; chapter 21 of ref. 79].
a diphtheria antigen, such as a diphtheria toxoid [e.g. chapter 13 of ref. 79].
a tetanus antigen, such as a tetanus toxoid [e.g. chapter 27 of ref. 79].
a saccharide antigen from Haemophilus influenzae B [e.g. chapter 14 of ref. 79]
an antigen from N. gonorrhoeae [e.g. 57, 58, 59].
an antigen from Chlamydia pneumoniae [e.g. 80, 81, 82, 83, 84, 85, 86].
an antigen from Chlamydia trachomatis [e.g. 87].
an antigen from Porphyromonas gingivalis [e.g. 88].
polio antigen(s) [e.g. 89, 90; chapter 24 of ref. 79] such as IPV.
rabies antigen(s) [e.g. 91] such as lyophilised inactivated virus [e.g. 92, RabAvert™].
measles, mumps and/or rubella antigens [e.g. chapters 19, 20 and 26 of ref. 79].
influenza antigen(s) [e.g. chapters 17 & 18 of ref. 79], such as the haemagglutinin and/or neuraminidase surface proteins.
an antigen from Moraxella catarrhalis [e.g. 93].
an antigen from Streptococcus pyogenes (group A streptococcus) [e.g. 94, 95, 96].

Where a saccharide or carbohydrate antigen is used, it is preferably conjugated to a carrier in order to enhance immunogenicity. Conjugation of H. influenzae B, meningococcal and pneumococcal saccharide antigens is well known.

Toxic protein antigens may be detoxified where necessary (e.g. detoxification of pertussis toxin by chemical and/or genetic means [78]).

Where a diphtheria antigen is included in the composition it is preferred also to include tetanus antigen and pertussis antigens. Similarly, where a tetanus antigen is included it is preferred also to include diphtheria and pertussis antigens. Similarly, where a pertussis antigen is included it is preferred also to include diphtheria and tetanus antigens.

Antigens may be adsorbed to an aluminium salt.

Antigens in the composition will typically be present at a concentration of at least 1 μg/ml each. In general, the concentration of any given antigen will be sufficient to elicit an immune response against that antigen.

As an alternative to using proteins antigens in the composition of the invention, nucleic acid encoding the antigen may be used [e.g. refs. 97 to 105]. Protein components of the compositions of the invention may thus be replaced by nucleic acid (preferably DNA e.g. in the form of a plasmid) that encodes the protein.

In practical terms, there may be an upper limit to the number of antigens included in compositions of the invention. The number of antigens (including GBS antigens) in a composition of the invention may be less than 20, less than 19, less than 18, less than 17, less than 16, less than 15, less than 14, less than 13, less than 12, less than 11, less than 10, less than 9, less than 8, less than 7, less than 6, less than 5, less than 4, or less than 3. The number of GBS antigens in a composition of the invention may be less than 6, less than 5, or less than 4.

### Pharmaceutical Compositions and Methods

The invention provides processes for preparing pharmaceutical compositions, comprising the steps of mixing (a) a saccharide of the invention (optionally in the form of a conjugate) with (b) a pharmaceutically acceptable carrier. Typical ‘pharmaceutically acceptable carriers’ include any carrier that does not itself induce the production of antibodies harmful to the individual receiving the composition. Suitable carriers are typically large, slowly metabolised macromolecules such as proteins, polysaccharides, polylactic acids, polyglycolic acids, polymeric amino acids, amino acid copolymers, lactose, and lipid aggregates (such as oil droplets or liposomes). Such carriers are well known to those of ordinary skill in the art. The vaccines may also contain diluents, such as water, saline, glycerol, etc. Additionally, auxiliary substances, such as wetting or emulsifying agents, pH buffering substances, and the like, may be present. Sterile pyrogen-free, phosphate-buffered physiologic saline is a typical carrier. A thorough discussion of pharmaceutically acceptable excipients is available in reference 106.

The pharmaceutical compositions may be packaged into vials or into syringes. The syringes may be supplied with or without needles. A syringe will include a single dose of the composition, whereas a vial may include a single dose or multiple doses.

Aqueous compositions of saccharides of the invention are suitable for reconstituting other vaccines from a lyophilised form. Where a composition of the invention is to be used for such extemporaneous reconstitution, the invention provides a process for reconstituting such a lyophilised vaccine, comprising the step of mixing the lyophilised material with an aqueous composition of the invention. The reconstituted material can be used for injection.

### GBS Protein Antigens

As mentioned above, GBS proteins can be included in compositions of the invention. These may be used as carrier proteins for conjugates of the invention, carrier proteins for other conjugates, or as unconjugated protein antigens.

GBS protein antigens for use with the invention include those disclosed in references 94 and 107-109. Five preferred GBS protein antigens for use with the invention are known as: GBS67; GBS80; GBS104; GBS276; and GBS322 [see ref. 94]. Further details of these five antigens are given below.

The full-length sequences for these five GBS proteins are SEQ ID NOs 1 to 5 herein. Compositions of the invention may thus include (a) a polypeptide comprising an amino acid sequence selected from SEQ ID NOs 1 to 5, and/or (b) a polypeptide comprising (i) an amino acid sequence that has sequence identity to one or more of SEQ ID NOs 1 to 5 and/or (ii) a fragment of SEQ ID NOs 1 to 5.

Depending on the particular SEQ ID NO, the degree of sequence identity in (i) is preferably greater than 50% (e.g. 60%, 70%, 75%, 80%, 85%, 90%, 91%, 92%, 93%, 94%, 95%, 96%, 97%, 98%, 99% or more). These polypeptides include homologs, orthologs, allelic variants and functional mutants. Typically, 50% identity or more between two polypeptide sequences is considered to be an indication of functional equivalence. Identity between polypeptides is preferably determined by the Smith-Waterman homology search algorithm as implemented in the MPSRCH program (Oxford Molecular), using an affine gap search with parameters gap open penalty=12 and gap extension penalty=1.

Depending on the particular SEQ ID NO, the fragments of (ii) should comprise at least n consecutive amino acids from the sequences and, depending on the particular sequence, n is 7 or more (e.g. 8, 10, 12, 14, 16, 18, 20, 22, 24, 26, 28, 30, 35, 40, 45, 50, 60, 70, 80, 90, 100 or more). The fragment may comprise at least one T-cell or, preferably, a B-cell epitope of the sequence. T- and B-cell epitopes can be identified empirically (e.g. using PEPSCAN [110, 111] or similar methods), or they can be predicted (e.g. using the Jameson-Wolf antigenic index [112], matrix-based approaches [113], TEPITOPE [114], neural networks [115], OptiMer & EpiMer [116, 117], ADEPT [118], Tsites [119], hydrophilicity [120], antigenic index [121] or the methods disclosed in reference 122 etc.). Other preferred fragments are SEQ ID NOs 1 to 5 without their N-terminal amino acid residue or without their N-terminal signal peptide. Removal of one or more domains, such as a leader or signal sequence region, a transmembrane region, a cytoplasmic region or a cell wall anchoring motif can be used. Preferred fragments are given below (SEQ ID NOs 6 to 19).

These polypeptide may, compared to SEQ ID NOs 1 to 5, include one or more (e.g. 1, 2, 3, 4, 5, 6, 7, 8, 9, 10, etc.) conservative amino acid replacements i.e. replacements of one amino acid with another which has a related side chain. Genetically-encoded amino acids are generally divided into four families: (1) acidic i.e. aspartate, glutamate; (2) basic i.e. lysine, arginine, histidine; (3) non-polar i.e. alanine, valine, leucine, isoleucine, proline, phenylalanine, methionine, tryptophan; and (4) uncharged polar i.e. glycine, asparagine, glutamine, cystine, serine, threonine, tyrosine. Phenylalanine, tryptophan, and tyrosine are sometimes classified jointly as aromatic amino acids. In general, substitution of single amino acids within these families does not have a major effect on the biological activity. The polypeptides may also include one or more (e.g. 1, 2, 3, 4, 5, 6, 7, 8, 9, 10, etc.) single amino acid deletions relative to SEQ ID NOs 1 to 5. The polypeptides may also include one or more (e.g. 1, 2, 3, 4, 5, 6, 7, 8, 9, 10, etc.) insertions (e.g. each of 1, 2, 3, 4 or 5 amino acids) relative to the SEQ ID NOs 1 to 5.

Polypeptides of the invention can be prepared in many ways e.g. by chemical synthesis (in whole or in part), by digesting longer polypeptides using proteases, by translation from RNA, by purification from cell culture (e.g. from recombinant expression), from the organism itself (e.g. after bacterial culture, or direct from patients), etc. A preferred method for production of peptides <40 amino acids long involves in vitro chemical synthesis [123, 124]. Solid-phase peptide synthesis is particularly preferred, such as methods based on tBoc or Fmoc [125] chemistry. Enzymatic synthesis [126] may also be used in part or in full. As an alternative to chemical synthesis, biological synthesis may be used e.g. the polypeptides may be produced by translation. This may be carried out in vitro or in vivo. Biological methods are in general restricted to the production of polypeptides based on L-amino acids, but manipulation of translation machinery (e.g. of aminoacyl tRNA molecules) can be used to allow the introduction of D-amino acids (or of other non natural amino acids, such as iodotyrosine or methylphenylalanine, azidohomoalanine, etc.) [127]. Where D-amino acids are included, however, it is preferred to use chemical synthesis. Polypeptides of the invention may have covalent modifications at the C-terminus and/or N-terminus.

If these GBS proteins are included in compositions of the invention then they can take various forms (e.g. native, fusions, glycosylated, non-glycosylated, lipidated, non-lipidated, phosphorylated, non-phosphorylated, myristoylated, non-myristoylated, monomeric, multimeric, particulate, denatured, etc.). They are preferably used in purified or substantially purified form i.e. substantially free from other polypeptides (e.g. free from naturally-occurring polypeptides), particularly from other GBS or host cell polypeptides).

### GBS67

Nucleotide and amino acid sequence of GBS67 sequenced from serotype V strain 2603 V/R are set forth in ref. 94 as SEQ ID NOs 3745 & 3746. The amino acid sequence is SEQ ID NO:1 herein:

MRKYQKFSKILTLSLFCLSQIPLNTNVLGESTVPENGAKGKLVVKKTDDQNKPLSKATFVLKTTAHPESKIEKVTAELT
GEATFDNLIPGDYTLSEETAPEGYKKTNQTWQVKVESNGKTTIQNSGDKNSTIGQNQEELDKQYPPTGIYEDTKESYKL
EHVKGSVPNGKSEAKAVNPYSSEGEHIREIPEGTLSKRISEVGDLAHNKYKIELTVSGKTIVKPVDKQKPLDVVFVLDN
SNSMNNDGPNFQRHNKAKKAAEALGTAVKDILGANSDNRVALVTYGSDIFDGRSVDVVKGFKEDDKYYGLQTKFTIQTE
NYSHKQLTNNAEEIIKRIPTEAPKAKWGSTTNGLTPEQQKEYYLSKVGETFTMKAFMEADDILSQVNRNSQKIIVHVTD
GVPTRSYAINNFKLGASYESQFEQMKKNGYLNKSNFLLTDKPEDIKGNGESYFLFPLDSYQTQIISGNLQKLHYLDLNL
NYPKGTIYRNGPVKEHGTPTKLYINSLKQKNYDIFNFGIDISGFRQVYNEEYKKNQDGTFQKLKEEAFKLSDGEITELM
RSFSSKPEYYTPIVTSADTSNNEILSKIQQQFETILTKENSIVNGTIEDPMGDKINLQLGNGQTLQPSDYTLQGNDGSV
MKDGIATGGPNNDGGILKGVKLEYIGNKLYVRGLNLGEGQKVTLTYDVKLDDSFISNKFYDTNGRTTLNPKSEDPNTLR
DFPIPKIRDVREYPTITIKNEKKLGEIEFIKVDKDNNKLLLKGATFELQEFNEDYKLYLPIKNNNSKVVTGENGKISYK
DLKDGKYQLIEAVSPEDYQKITNKPILTFEVVKGSIKNIIAVNKQISEYHEEGDKHLITNTHIPPKGIIPMTGGKGILS
FILIGGAMMSIAGGIYIWKRYKKSSDMSIKKD

GBS67 contains a C-terminus transmembrane region which is indicated by the underlined region closest to the C-terminus of SEQ ID NO: 1 above. One or more amino acids from the transmembrane region may be removed, or the amino acid may be truncated before the transmembrane region. An example of such a GBS67 fragment is set forth below as SEQ ID NO: 18.

MRKYQKFSKILTLSLFCLSQIPLNTNVLGESTVPENGAKGKLVVKKTDDQNKPLSKATFVLKTTAHPESKIEKVTAELT
GEATFDNLIPGDYTLSEETAPEGYKKTNQTWQVKVESNGKTTIQNSGDKNSTIGQNQEELDKQYPPTGIYEDTKESYKL
EHVKGSVPNGKSEAKAVNPYSSEGEHIREIPEGTLSKRISEVGDLAHNKYKIELTVSGKTIVKPVDKQKPLDVVFVLDN
SNSMNNDGPNFQRHNKAKKAAEALGTAVKDILGANSDNRVALVTYGSDIFDGRSVDVVKGFKEDDKYYGLQTKFTIQTE
NYSHKQLTNNAEEIIKRIPTEAPKAKWGSTTNGLTPEQQKEYYLSKVGETFTMKAFMEADDILSQVNRNSQKIIVHVTD
GVPTRSYAINNFKLGASYESQFEQMKKNGYLNKSNFLLTDKPEDIKGNGESYFLFPLDSYQTQIISGNLQKLHYLDLNL
NYPKGTIYRNGPVKEHGTPTKLYINSLKQKNYDIFNFGIDISGFRQVYNEEYKKNQDGTFQKLKEEAFKLSDGEITELM
RSFSSKPEYYTPIVTSADTSNNEILSKIQQQFETILTKENSIVNGTIEDPMGDKINLQLGNGQTLQPSDYTLQGNDGSV
MKDGIATGGPNNDGGILKGVKLEYIGNKLYVRGLNLGEGQKVTLTYDVKLDDSFISNKFYDTNGRTTLNPKSEDPNTLR
DFPIPKIRDVREYPTITIKNEKKLGEIEFIKVDKDNNKLLLKGATFELQEFNEDYKLYLPIKNNNSKVVTGENGKISYK
DLKDGKYQLIEAVSPEDYQKITNKPILTFEVVKGSIKNIIAVNKQISEYHEEGDKHLITNTHIPPKGIIPMTGGKGILS

GBS67 contains an amino acid motif indicative of a cell wall anchor, shown in italics in SEQ ID NO: 1 above. In some recombinant host cell systems, it may be preferable to remove this motif to facilitate secretion of a recombinant GBS67 protein from the host cell. Accordingly, in one preferred fragment of GBS67 for use in the invention, the transmembrane and the cell wall anchor motif are removed from GBS67. An example of such a GBS67 fragment is set forth below as SEQ ID NO: 19.

MRKYQKFSKILTLSLFCLSQIPLNTNVLGESTVPENGAKGKLVVKKTDDQNKPLSKATFVLKTTAHPESKIEKVTAELT
GEATFDNLIPGDYTLSEETAPEGYKKTNQTWQVKVESNGKTTIQNSGDKNSTIGQNQEELDKQYPPTGIYEDTKESYKL
EHVKGSVPNGKSEAKAVNPYSSEGEHIREIPEGTLSKRISEVGDLAHNKYKIELTVSGKTIVKPVDKQKPLDVVFVLDN
SNSMNNDGPNFQRHNKAKKAAEALGTAVKDILGANSDNRVALVTYGSDIFDGRSVDVVKGFKEDDKYYGLQTKFTIQTE
NYSHKQLTNNAEEIIKRIPTEAPKAKWGSTTNGLTPEQQKEYYLSKVGETFTMKAFMEADDILSQVNRNSQKIIVHVTD
GVPTRSYAINNFKLGASYESQFEQMKKNGYLNKSNFLLTDKPEDIKGNGESYFLFPLDSYQTQIISGNLQKLHYLDLNL
NYPKGTIYRNGPVKEHGTPTKLYINSLKQKNYDIFNFGIDISGFRQVYNEEYKKNQDGTFQKLKEEAFKLSDGEITELM
RSFSSKPEYYTPIVTSADTSNNEILSKIQQQFETILTKENSIVNGTIEDPMGDKINLQLGNGQTLQPSDYTLQGNDGSV
MKDGIATGGPNNDGGILKGVKLEYIGNKLYVRGLNLGEGQKVTLTYDVKLDDSFISNKFYDTNGRTTLNPKSEDPNTLR
DFPIPKIRDVREYPTITIKNEKKLGEIEFIKVDKDNNKLLLKGATFELQEFNEDYKLYLPIKNNNSKVVTGENGKISYK
DLKDGKYQLIEAVSPEDYQKITNKPILTFEVVKGSIKNIIAVNKQISEYHEEGDKHLITNTHIPPKGI

### GBS80

GBS80 refers to a putative cell wall surface anchor family protein. Nucleotide and amino acid sequence of GBS80 sequenced from serotype V isolated strain 2603 V/R are set forth in ref. 94 as SEQ ID NOs 8779 & 8780. The amino acid sequence is set forth below as SEQ ID NO: 2:

MKLSKKLLFSAAVLTMVAGSTVEPVAQFATGMSIVRAAEVSQERPAKTTVNIYKLQADSYKSEITSNGGIENKDGEVIS
NYAKLGDNVKGLQGVQFKRYKVKTDISVDELKKLTTVEAADAKVGTILEEGVSLPQKTNAQGLVVDALDSKSNVRYLYV
EDLKNSPSNITKAYAVPFVLELPVANSTGTGFLSEINIYPKNVVTDEPKTDKDVKKLGQDDAGYTIGEEFKWFLKSTIP
ANLGDYEKFEITDKFADGLTYKSVGKIKIGSKTLNRDEHYTIDEPTVDNQNTLKITFKPEKFKEIAELLKGMTLVKNQD
ALDKATANTDDAAFLEIPVASTINEKAVLGKAIENTFELQYDHTPDKADNPKPSNPPRKPEVHTGGKRFVKKDSTETQT
LGGAEFDLLASDGTAVKWTDALIKANTNKNYIAGEAVTGQPIKLKSHTDGTFEIKGLAYAVDANAEGTAVTYKLKETKA
PEGYVIPDKEIEFTVSQTSYNTKPTDITVDSADATPDTIKNNKRPSIPNTGGIGTAIFVAIGAAVMAFAVKGMKRRTKD
N

GBS80 contains a N-terminal leader or signal sequence region which is indicated by the underlined sequence above. One or more amino acids from the leader or signal sequence region of GBS80 can be removed. An example of such a GBS80 fragment is set forth below as SEQ ID NO: 6:

AEVSQERPAKTTVNIYKILQADSYKSEITSNGGIENKDGEVISNYAKLGDNVKGLQGVQFKRYKVKTDISVDELKKLTTV
EAADAKVGTILEEGVSLPQKTNAQGLVVDALDSKSNVRYLYVEDLKNSPSNITKAYAVPFVLELPVANSTGTGFLSEIN
IYPKNVVTDEPKTDKDVKKLGQDDAGYTIGEEFKWFLKSTIPANLGDYEKFEITDKFADGLTYKSVGKIKIGSKTLNRD
EHYTIDEPTVDNQNTLKITFKPEKFKEIAELLKGMTLVKNQDALDKATANTDDAAFLEIPVASTINEKAVLGKAIENTF
ELQYDHTPDKADNPKPSNPPRKPEVHTGGKRFVKKDSTETQTLGGAEFDLLASDGTAVKWTDALIKANTNKNYIAGEAV
TGQFIKLKSHTDGTFEIKGLAYAVDANAEGTAVTYKLKETKAPEGYVIPDKEIEFTVSQTSYNTKPTDITVDSADATPD
TIKNNKRPSIPNTGGIGTAIFVAIGAAVMAFAVKGMKRRTKDN

GBS80 contains a C-terminal transmembrane region which is indicated by the underlined sequence near the end of SEQ ID NO: 2 above. One or more amino acids from the transmembrane region and/or a cytoplasmic region may be removed. An example of such a fragment is set forth below as SEQ ID NO:7:

MKLSKKLLFSAAVLTMVAGSTVEPVAQFATGMSIVRAAEVSQERPAKTTVNIYKLQADSYKSEITSNGGIENKDGEVIS
NYAKLGDNVKGLQGVQFKRYKVKTDISVDELKKLTTVEAADAKVGTILEEGVSLPQKTNAQGLVVDALDSKSNVRYLYV
EDLKNSPSNITKAYAVPFVLELPVANSTGTGFLSEINIYPKNVVTDEPKTDKDVKKLGQDDAGYTIGEEFKWFLKSTIP
ANLGDYEKFEITDKFADGLTYKSVGKIKIGSKTLNRDEHYTIDEPTVDNQNTLKITFKPEKFKEIAELLKGMTLVKNQD
ALDKATANTDDAAFLEIPVASTINEKAVLGKAIENTFELQYDHTPDKADNPKPSNPPRKPEVHTGGKRFVKKDSTETQT
LGGAEFDLLASDGTAVKWTDALIKANTNKNYIAGEAVTGQPIKLKSHTDGTFEIKGLAYAVDANAEGTAVTYKLKETKA
PEGYVIPDKEIEFTVSQTSYNTKPTDITVDSADATPDTIKNNKRPSIPNTG

GBS80 contains an amino acid motif indicative of a cell wall anchor, shown in italics in SEQ ID NO: 2 above. In some recombinant host cell systems, it may be preferable to remove this motif to facilitate secretion of a recombinant GBS80 protein from the host cell. Thus the transmembrane and/or cytoplasmic regions and the cell wall anchor motif may be removed from GBS80. An example of such a fragment is set forth below as SEQ ID NO: 8.

MKLSKKLLFSAAVLTMVAGSTVEPVAQFATGMSIVRAAEVSQERPAKTTVNIYKLQADSYKSEITSNGGIENKDGEVIS
NYAKLGDNVKGLQGVQFKRYKVKTDISVDELKKLTTVEAADAKVGTILEEGVSLPQKTNAQGLVVDALDSKSNVRYLYV
EDLKNSPSNITKAYAVPFVLELPVANSTGTGFLSEINIYPKNVVTDEPKTDKDVKKLGQDDAGYTIGEEFKWFLKSTIP
ANLGDYEKFEITDKFADGLTYKSVGKIKIGSKTLNRDEHYTIDEPTVDNQNTLKITFKPEKFKEIAELLKGMTLVKNQD
ALDKATANTDDAAFLEIPVASTINEKAVLGKAIENTFELQYDHTPDKADNPKPSNPPRKPEVHTGGRFVKKDSTETQT
LGGAEFDLLASDGTAVKTDALIKANTNKNYIAGEAVTGQPIKLKSHTDGTFEIKGLAYAVDANAEGTAVTYKLKETKA
PEGYVIPDKEIEFTVSQTSYNTKPTDITVDSADATPDTIKNNKRPS

Alternatively, in some recombinant host cell systems, it may be preferable to use the cell wall anchor motif to anchor the recombinantly expressed protein to the cell wall. The extracellular domain of the expressed protein may be cleaved during purification or the recombinant protein may be left attached to either inactivated host cells or cell membranes in the final composition.

In one embodiment, the leader or signal sequence region, the transmembrane and cytoplasmic regions and the cell wall anchor motif are removed from the GBS80 sequence. An example of such a GBS80 fragment is set forth below as SEQ ID NO: 9:

AEVSQERPAKTTVNIYKLQADSYKSEITSNGGIENKDGEVISNYAKLGDNVKGLQGVQFKRYKVKTDISVDELKKLTTV
EAADAKVGTILEEGVSLPQKTNAQGLVVDALDSKSNVRYLYVEDLKNSPSNITKAYAVPFVLELPVANSTGTGFLSEIN
IYPKNVVTDEPKTDKDVKKLGQDDAGYTIGEEFKWFLKSTIPANLGDYEKFEITDKFADGLTYKSVGKIKIGSKTLNRD
EHYTIDEPTVDNQNTLKITFKPEKFKEIAELLKGMTLVKNQDALDKATANTDDAAFLEIPVASTINEKAVLGKAIENTF
ELQYDHTPDKADNPKPSNPPRKPEVHTGGKRFVKKDSTETQTLGGAEFDLLASDGTAVKWTDALIKANTNKNYIAGEAV
TGQPIKLKSHTDGTFEIKGLAYAVDANAEGTAVTYKLKETKAPEGYVIPDKEIEFTVSQTSYNTKPTDITVDSADATPD
TIKNNKRPS

A particularly immunogenic fragment of GBS80 is located towards the N-terminus of the protein, and is given herein as SEQ ID NO: 10:

AEVSQERPAKTTVNIYKLQADSYKSEITSNGGIENKDGEVISNYAKLGDNVKGLQGVQFKRYKVKTDISVDELKKLTTV
EAADAKVGTILEEGVSLPQKTNAQGLVVDALDSKSNVRYLYVEDLKNSPSNITKAYAVPFVLELPVANSTGTGFLSEIN
IYPKNVVTDEPKTDKDVKKLGQDDAGYTIGEEFKWFLKSTIPANLGDYEKFEITDKFADGLTYKSVGKIKIGSKTLNRD
EHYTIDEPTVDNQNTLKITFKPEKFKEIAELLKG

### GBS104

GBS104 refers to a putative cell wall surface anchor family protein. It has been referred to as emaA. Nucleotide and amino acid sequences of GBS104 sequenced from serotype V isolated strain 2603 V/R are set forth in Ref. 94 as SEQ ID 8777 and SEQ ID 8778. The amino acid sequence is SEQ ID NO: 3 herein:

MKKRQKIWRGLSVTLLILSQIPFGILVQGETQDTNQALGKVIVKKTGDNATPLGKATFVLKNDNDKSETSHETVEGSGE
ATFENIKPGDYTLREETAPIGYKKTDKTWKVKVADNGATIIEGMDADKAEKRKEVLNAQYPKSAIYEDTKENYPLVNVE
GSKVGEQYKALNPINGKDGRREIAEGWLSKKITGVNDLDKNKYKIELTVEGKTTVETKELNQPLDVVVLLDNSNSMNNE
RANNSQRALKAGEAVEKLIDKITSNKDNRVALVTYASTIFDGTEATVSKGVADQNGKALNDSVSWDYHKTTFTATTHNY
SYLNLTNDANEVNILKSRIPKEAEHINGDRTLYQFGATFTQKALMKANEILETQSSNARKKLIFHVTDGVPTMSYAINF
NPYISTSYQNQFNSFLNKIPDRSGILQEDFIINGDDYQIVKGDGESFKLFSDRKVPVTGGTTQAAYRVPQNQLSVMSNE
GYAINSGYIYLYWRDYNWVYPFDPKTKKVSATKQIKTHGEPTTLYFNGNIRPKGYDIFTVGIGVNGDPGATPLEAEKFM
QSISSKTENYTNVDDTNKIYDELNKYFKTIVEEKHSIVDGNVTDPMGEMIEFQLKNGQSFTHDDYVLVGNDGSQLKNGV
ALGGPNSDGGILKDVTVTYDKTSQTIKINHLNLGSGQKVVLTYDVRLKDNYISNKFYNTNNRTTLSPKSEKEPNTIRDF
PIPKIRDVREFPVLTISNQKKMGEVEFIKVNKDKHSESLLGAKFQLQIEKDFSGYKQFVPEGSDVTTKNDGKIYFKALQ
DGNYKLYEISSPDGYIEVKTKPVVTFTIQNGEVTNLKADPNANKNQIGYLEGNGKHLITNTPKRPPGVFPKTGGIGTIV
YILVGSTFMILTICSFRRKQL

GBS104 contains an N-terminal leader or signal sequence region which is indicated by the underlined sequence at the beginning of SEQ ID NO: 3 above. One or more amino acids from the leader or signal sequence region of GBS104 may be removed. An example of such a GBS104 fragment is set forth below as SEQ ID NO 11.

GETQDTNQALGKVIVKKTGDNATPLGKATFVLKNDNDKSETSHETVEGSGEATFENIKPGDYTLREETAPIGYKKTDKT
WKVKVADNGATIIEGMDADKAEKRKEVLNAQYPKSAIYEDTKENYPLVNVEGSKVGEQYKALNPINGKDGRREIAEGWL
SKKITGVNDLDKNKYKIELTVEGKTTVETKELNQPLDVVVLLDNSNSMNNERANNSQRALKAGEAVEKLIDKITSNKDN
RVALVTYASTIFDGTEATVSKGVADQNGKALNDSVSWDYHKTTFTATTHNYSYLNLTNDANEVNILKSRIPKEAEHING
DRTLYQFGATFTQKALMKANEILETQSSNARKKLIFHVTDGVPTMSYAINFNPYISTSYQNQFNSFLNKIPDRSGILQE
DFIINGDDYQIVKGDGESFKLFSDRKVPVTGGTTQAAYRVPQNQLSVMSNEGYAINSGYIYLYWRDYNWVYPFDPKTKK
VSATKQIKTHGEPTTLYFNGNIRPKGYDIFTVGIGVNGDPGATPLEAEKFMQSISSKTENYTNVDDTNKIYDELNKYFK
TIVEEKHSIVDGNVTDPMGEMIEFQLKNGQSFTHDDYVLVGNDGSQLKNGVALGGPNSDGGILKDVTVTYDKTSQTIKI
NHLNLGSGQKVVLTYDVRLKDNYISNKFYNTNNRTTLSPKSEKEPNTIRDFPIPKIRDVREFPVLTISNQKKMGEVEFI
KVNKDKHSESLLGAKFQLQIEKDFSGYKQFVPEGSDVTTKNDGKIYFKALQDGNYKLYEISSPDGYIEVKTKPVVTFTI
QNGEVTNLKADPNANKNQIGYLEGNGKHLITNTPKRPPGVFPKTGGIGTIVYILVGSTFMILTICSFRRKQL

GBS104 contains a C-terminal transmembrane and/or cytoplasmic region which is indicated by the underlined region near the end of SEQ ID NO:3 above. One or more amino acids from the transmembrane or cytoplasmic regions may be removed. An example of such a GBS104 fragment is set forth below as SEQ ID NO 12:

MKKRQKIWRGLSVTLLILSQIPFGILVQGETQDTNQALGKVIVKKTGDNATPLGKATFVLKNDNDKSETSHETVEGSGE
ATFENIKPGDYTLREETAPIGYKKTDKTWKVKVADNGATIIEGMDADKAEKRKEVLNAQYPKSAIYEDTKENYPLVNVE
GSKVGEQYKALNPINGKDGRREIAEGWLSKKITGVNDLDKNKYKIELTVEGKTTVETKELNQPLDVVVLLDNSNSMNNE
RANNSQRALKAGEAVEKLIDKITSNKDNRVALVTYASTIFDGTEATVSKGVADQNGKALNDSVSWDYHKTTFTATTHNY
SYLNLTNDANEVNILKSRIPKEAEHINGDRTLYQFGATFTQKALMKANEILETQSSNARKKLIFHVTDGVPTMSYAINF
NPYISTSYQNQFNSFLNKIPDRSGILQEDFIINGDDYQIVKGDGESFKLFSDRKVPVTGGTTQAAYRVPQNQLSVMSNE
GYAINSGYIYLYWRDYNWVYPFDPKTKKVSATKQIKTHGEPTTLYFNGNIRPKGYDIFTVGIGVNGDPGATPLEAEKFM
QSISSKTENYTNVDDTNKIYDELNKYFKTIVEEKHSIVDGNVTDPMGEMIEFQLKNGQSFTHDDYVLVGNDGSQLKNGV
ALGGPNSDGGILKDVTVTYDKTSQTIKINHLNLGSGQKVVLTYDVRLKDNYISNKFYNTNNRTTLSPKSEKEPNTIRDF
PIPKIRDVREFPVLTISNQKKMGEVEFIKVNKDKHSESLLGAKFQLQIEKDFSGYKQFVPEGSDVTTKNDGKIYFKALQ
DGNYKLYEISSPDGYIEVKTKPVVTFTIQNGEVTNLKADPNANKNQIGYLEGNGKHLITNT

One or more amino acids from the leader or signal sequence region and one or more amino acids from the transmembrane or cytoplasmic regions may be removed. An example of such a GBS104 fragment is set forth below as SEQ ID NO 13:

GETQDTNQALGKVIVKKTGDNATPLGKATFVLKNDNDKSETSHETVEGSGEATFENIKPGDYTLREETAPIGYKKTDKT
WKVKVADNGATIIEGMDADKAEKRKEVLNAQYPKSAIYEDTKENYPLVNVEGSKVGEQYKALNPINGKDGRREIAEGWL
SKKITGVNDLDKNKYKIELTVEGKTTVETKELNQPLDVVVLLDNSNSMNNERANNSQRALKAGEAVEKLIDKITSNKDN
RVALVTYASTIFDGTEATVSKGVADQNGKALNDSVSWDYHKTTFTATTHNYSYLNLTNDANEVINLKSRIPKEAEHING
DRTLYQFGATFTQKALMKANEILETQSSNARKKLIFHVTDGVPTMSYAINFNPYISTSYQNQFNSFLNKIPDRSGILQE
DFIINGDDYQIVKGDGESFKLFSDRKVPVTGGTTQAAYRVPQNQLSVMSNEGYAINSGYIYLYWRDYNWVYPFDPKTKK
VSATKQIKTHGEPTTLYFNGNIRPKGYDIFTVGIGVNGDPGATPLEAEKFMQSISSKTENYTNVDDTNKIYDELNKYFK
TIVEEKHSIVDGNVTDPMGEMIEFQLKNGQSFTHDDYVLVGNDGSQLKNGVALGGPNSDGGILKDVTVTYDKTSQTIKI
NHLNLGSGQKVVLTYDVRLKDNYISNKFYNTNNRTTLSPKSEKEPNTIRDFPIPKIRDVREFPVLTISNQKKMGEVEFI
KVNKDKHSESLLGAKFQLQIEKDFSGYKQFVPEGSDVTTKNDGKIYFKALQDGNYKLYEISSPDGYIEVKTKPVVTFTI
QNGEVTNLKADPNANKNQIGYLEGNGKHLITNT

Further fragments of GBS104 include an 830 amino acid fragment of GBS104 of amino acids 28-858 (numbered by SEQ ID NO: 3), a 359 amino acid fragment of GBS104 of amino acids 28-387, a 581 amino acid fragment of GBS104 of amino acids 28-609, or a 740 amino acid fragment of GBS104 of amino acids 28-768.

### GBS276

GBS276 refers to a C5a peptidase. Further description of GBS276 can be found in references 128-131. Nucleotide and amino acid sequences of GBS276 sequenced from serotype V isolated strain 2603 V/R are set forth in Ref. 94 as SEQ ID NOs 8941 & 8942. The amino acid sequence is SEQ ID NO: 4 herein:

MRKKQKLPFDKLAIALISTSILLNAQSDIKANTVTEDTPATEQAVEPPQPIAVSEESRSSKETKTSQTPSDVGETVADD
ANDLAPQAPAKTADTPATSKATIRDLNDPSHVKTLQEKAGKGAGTVVAVIDAGFDKNHEAWRLTDKTKARYQSKENLEK
AKKEHGITYGEWVNDKVAYYHDYSKDGKNAVDQEHGTHVSGILSGNAPSEMKEPYRLEGAMPEAQLLLMRVEIVNGLAD
YARNYAQAIRDAVNLGAKVINMSFGNAALAYANLPDETKKAFDYAKSKGVSIVTSAGNDSSFGGKPRLPLADHPDYGVV
GTPAAADSTLTVASYSPDKQLTETATVKTDDHQDKEMPVISTNRFEPNKAYDYAYANRGTKEDDFKDVEGKIALIERGD
IDFKDKIANAKKAGAVGVLIYDNQDKGFPIELPNVDQMPAAFISRRDGLLLKDNPPKTITFNATPKVLPTASGTKLSRF
SSWGLTADGNIKPDIAAPGQDILSSVANNKYAKLSGTSMSAPLVAGIMGLLQKQYETQYPDMTPSERLDLAKKVLMSSA
TALYDEDEKAYFSPRQQGAGAVDAKKASAATMYVTDKDNTSSKVHLNNVSDKFEVTVTVHNKSDKPQELYYQVTVQTDK
VDGKHFALAPKALYETSWQKITIPANSSKQVTVPIDASRFSKDLLAQMKNGYFLEGFVRFKQDPTKEELMSIPYIGFRG
DFGNLSALEKPIYDSKDGSSYYHEANSDAKDQLDGDGLQFYALKNNFTALTTESNPWTIIKAVKEGVENIEDIESSEIT
ETIFAGTFAKQDDDSHYYIHRHANGKPYAAISPNGDGNRDYVQJQGTFLRNAKNLVAEVLDKEGNVVWTSEVTEQVVKN
YNNDLASTLGSTRFEKTRWDGKDKDGKVVANGTYTYRVRYTPISSGAKEQHTDFDVIVDNTTPEVATSATFSTEDSRLT
LASKPKTSQPVYRERIAYTYMDEDLPTTEYISPNEDGTFTLPEEAETMEGATVPLKMSDFTYVVEDMAGNITYTPVTKL
LEGHSNKPEQDGSDQAPDKKPEAKPEQDGSGQTPDKKKETKPEKDSSGQTPGKTPQKGQSSRTLEKRSSKRALATKAST
RDQLPTTNDKDTNRLHLLKLVMTTFFLG

GBS276 contains an N-terminal leader or signal sequence region which is indicated by the underlined sequence at the beginning of SEQ ID NO: 4 above. One or more amino acids from the leader or signal sequence region of GBS276 may be removed. An example of such a GBS276 fragment is set forth below as SEQ ID NO: 14:

QSDIKANTVTEDTPATEQAVEPPQPIAVSEESRSSKETKTSQTPSDVGETVADDANDLAPQAPAKTADTPATSKATIRD
LNDPSHVKTLQEKAGKGAGTVVAVIDAGFDKNHEAWRLTDKTKARYQSKENLEKAKKEHGITYGEWVNDKVAYYHDYSK
DGKNAVDQEHGTHVSGILSGNAPSEMKEPYRLEGANPEAQLLLMRVEIVNGLADYARNYAQAIRDAVNLGAKVINMSFG
NAALAYANLPDETKKAFDYAKSKGVSIVTSAGNDSSFGGKPRLPLADHPDYGVVGTPAAADSTLTVASYSPDKQLTETA
TVKTDDHQDKEMPVISTNRFEPNKAYDYAYANRGTKEDDFKDVEGKIALIERGDIDFKDKIANAKKAGAVGVLIYDNQD
KGFPIELPNVDQMPAAFISRRDGLLLKDNPFKTITFNATPKVLPTASGTKLSRFSSWGLTADGNIKPDIAAPGQDILSS
VANNKYAKLSGTSMSAPLVAGIMGLLQKQYETQYPDMTPSERLDLAKKVLMSSATALYDEDEKAYFSPRQQGAGAVDAK
KASAATMYVTDKDNTSSKVHLNNVSDKFEVTVTVHNKSDKPQELYYQVTVQTDKVDGKHFALAPKALYETSWQKITIPA
NSSKQVTVPIDASRFSKDLLAQMKNGYFLEGFVRFKQDPTKEELMSIPYIGFRGDFGNLSALEKPIYDSKDGSSYYHEA
NSDAKDQLDGDGLQFYALKNNFTALTTESNPWTIIKAVKEGVENIEDIESSEITETIFAGTFAKQDDDSHYYIHRHANG
KPYAAISPNGDGNRDYVQFQGTFLRNAKNLVAEVLDKEGNVVWTSEVTEQVVKNYNNDLASTLGSTRFEKTRWDGKDKD
GKVVANGTYTYRVRYTPISSGAKEQHTDFDVIVDNTTPEVATSATFSTEDSRLTLASKPKTSQPVYRERIAYTYMDEDL
PTTEYISPNEDGTFTLPEEAETMEGATVPLKMSDFTYVVEDMAGNITYTPVTKLLEGHSNKPEQDGSDQAPDKKPEAKP
EQDGSGQTPDKKKETKPEKDSSGQTPGKTPQKGQSSRTLEKRSSKRALATKASTRDQLPTTNDKDTNRLHLLKLVMTTF
FLG

GBS276 contains a C-terminal transmembrane and/or cytoplasmic region which is indicated by the underlined sequence near the end of SEQ ID NO: 4 above. One or more amino acids from the transmembrane or cytoplasmic regions of GBS276 may be removed. An example of such a GBS276 fragment is set forth below as SEQ ID NO: 15:

MRKKQKLPFDKLAIALISTSILLNAQSDIKANTVTEDTPATEQAVEPPQPIAVSEESRSSKETKTSQTPSDVGETVADD
ANDLAPQAPAKTADTPATSKATIRDLNDPSHVKTLQEKAGKGAGTVVAVIDAGFDKNHEAWRLTDKTKARYQSKENLEK
AKKEHGITYGEWVNDKVAYYHDYSKDGKNAVDQEHGTHVSGILSGNAPSEMKEPYRLEGAMPEAQLLLMRVEIVNGLAD
YARNYAQAIRDAVNLGAKVINMSFGNAALAYANLPDETKKAFDYAKSKGVSIVTSAGNDSSFGGKPRLPLADHPDYGVV
GTPAAADSTLTVASYSPDKQLTETATVKTDDHQDKEMPVISTNRFEPNKAYDYAYANRGTKEDDFKDVEGKIALIERGD
IDFKDKIANAKKAGAVGVLIYDNQDKGFPIELPNVDQMPAAFISRRDGLLLKDNPPKTITFNATPKVLPTASGTKLSRF
SSWGLTADGNIKPDIAAPGQDILSSVANNKYAKLSGTSMSAPLVAGIMGLLQKQYETQYPDMTPSERLDLAKKVLMSSA
TALYDEDEKAYFSPRQQGAGAVDAKKASAATMYVTDKDNTSSKVHLNNVSDKFEVTVTVHNKSDKPQELYYQVTVQTDK
VDGKHFALAPKALYETSWQKITIPANSSKQVTVPIDASRFSKDLLAQMKNGYFLEGFVRFKQDPTKEELMSIPYIGFRG
DFGNLSALEKPIYDSKDGSSYYHEANSDAKDQLDGDGLQFYALKNNFTALTTESNPWTIIKAVKEGVENIEDIESSEIT
ETIFAGTFAKQDDDSHYYIHRHANGKPYAAISPNGDGNRDYVQFQGTFLRNAKNLVAEVLDKEGNVVWTSEVTEQVVKN
YNNDLASTLGSTRFEKTRWDGKDKDGKVVANGTYTYRVRYTPISSGAKEQHTDFDVIVDNTTPEVATSATFSTEDSRLT
LASKPKTSQPVYRERIAYTYMDEDLPTTEYISPNEDGTFTLPEEAETMEGATVPLKMSDFTYVVEDMAGNITYTPVTKL
LEGHSNKPEQDGSDQAPDKKPEAKPEQDGSGQTPDKKKETKPEKDSSGQTPGKTPQKGQSSRTLEKRSSKRALATK

One or more amino acids from the leader or signal sequence region and one or more amino acids from the transmembrane or cytoplasmic regions of GBS276 may be removed. An example of such a GBS276 fragment is set forth below as SEQ ID NO: 16:

QSDIKANTVTEDTPATEQAVEPPQPIAVSEESRSSKETKTSQTPSDVGETVADDANDLAPQAPAKTADTPATSKATIRD
LNDPSHVKTLQEKAGKGAGTVVAVIDAGFDKNHEAWRLTDKTKARYQSKENLEKAKKEHGITYGEWVNDKVAYYHDYSK
DGKNAVDQEHGTHVSGILSGNAPSEMKEPYRLEGAMPEAQLLLMRVEIVNGLADYARNYAQAIRDAVNLGAKVINMSFG
NAALAYANLPDETKKAFDYAKSKGVSIVTSAGNDSSFGGKPRLPLADHPDYGVVGTPAAADSTLTVASYSPDKQLTETA
TVKTDDHQDKEMPVISTNRFEPNKAYDYAYANRGTKEDDFKDVEGKIALIERGDIDFKDKIANAKKAGAVGVLIYDNQD
KGFPIELPNVDQMPAAFISRRDGLLLKDNPPKTITFNATPKVLPTASGTKLSRFSSWGLTADGNIKPDIAAPGQDILSS
VANNKYAKLSGTSMSAPLVAGIMGLLQKQYETQYPDMTPSERLDLAKKVLMSSATALYDEDEKAYFSPRQQGAGAVDAK
KASAATMYVTDKDNTSSKVHLNNVSDKFEVTVTVHNKSDKPQELYYQVTVQTDKVDGKHFALAPKALYETSWQKITIPA
NSSKQVTVPIDASRFSKDLLAQMKNGYFLEGFVRFKQDPTKEELMSIPYIGFRGDFGNLSALEKPIYDSKDGSSYYHEA
NSDAKDQLDGDGLQFYALKNNFTALTTESNPWTIIKAVKEGVENIEDIESSEITETIFAGTFAKQDDDSHYYIHRHANG
KPYAAISPNGDGNRDYVQFQGTFLRNAKNLVAEVLDKEGNVVWTSEVTEQVVVVYNNDLASTLGSTRFEKTRWDGKDKD
GKVVANGTYTYRVRYTPISSGAKEQHTDFDVIVDNTTPEVATSATFSTEDSRLTLASKPKTSQPVYRERIAYTYMDEDL
PTTEYISPNEDGTFTLPEEAETNEGATVPLKMSDFTYVVEDMAGNITYTPVTKLLEGHSNKPEQDGSDQAPDKKPEAKP
EQDGSGQTPDKKKETKPEKDSSGQTPGKTPQKGQSSRTLEKRSSKRALATK

### GBS322.

GBS322 refers to a surface immunogenic protein, also referred to as ‘sip’. Nucleotide and amino acid sequences of GBS322 sequenced from serotype V isolated strain 2603 V/R are set forth in Ref. 94 as SEQ ID NOs 8539 & 8540. The amino acid sequence is SEQ ID NO: 5 herein:

MNKKVLLTSTMAASLLSVASVQAQETDTTWTARTVSEVKADLVKQDNKSSYTVKYGDTLSVISEAMSIDMNVLAKINNI
ADINLIYPETTLTVTYDQKSHTATSMKIETPATNAAGQTTATVDLKTNQVSVADQKVSLNTISEGMTPEAATTIVSPMK
TYSSAPALKSKEVLAQEQAVSQAAANEQVSPAPVKSITSEVPAAKEEVKPTQTSVSQSTTVSPASVAAETPAPVAKVAP
VRTVAAPRVASVKVVTPKVETGASPEHVSAPAVPVTTTSPATDSKLQATEVKSVPVAQKAPTATPVAQPASTTNAVAAH
PENAGLQPHVAAYKEKVASTYGVNEFSTYRAGDPGDHGKGLAVDFIVGTNQALGNKVAQYSTQNMAANNISYVIWQQKF
YSNTNSIYGPANTWNAMPDRGGVTANHYDHVHVSFNK

GBS322 contains a N-terminal leader or signal sequence region which is indicated by the underlined sequence near the beginning of SEQ ID NO: 5. One or more amino acids from the leader or signal sequence region of GBS322 may be removed. An example of such a GBS322 fragment is set forth below as SEQ ID NO: 17:

DLVKQDNKSSYTVKYGDTLSVISEAMSIDMNVLAKINNIADINLIYPETTLTVTYDQKSHTATSMKIETPATNAAGQTT
ATVDLKTNQVSVADQKVSLNTISEGMTPEAATTIVSPMKTYSSAPALKSKEVLAQEQAVSQAAANEQVSPAPVKSITSE
VPAAKEEVKPTQTSVSQSTTVSPASVAAETPAPVAKVAPVRTVAAPRVASVKVVTPKVETGASPEHVSAPAVPVTTTSP
ATDSKLQATEVKSVPVAQKAPTATPVAQPASTTNAVAAHPENAGLQPHVAAYKEKVASTYGVNEFSTYRAGDPGDHGKG
LAVDFIVGTNQALGNKVAQYSTQNMAANNISYVIWQQKFYSNTNSIYGPANTWNAMPDRGGVTANHYDHVHVSFNK

### General

The term “comprising” encompasses “including” as well as “consisting” e.g. a composition “comprising” X may consist exclusively of X or may include something additional e.g. X+Y.

The term “about” in relation to a numerical value x means, for example, x±10%.

The word “substantially” does not exclude “completely” e.g. a composition which is “substantially free” from Y may be completely free from Y. Where necessary, the word “substantially” may be omitted from the definition of the invention.

Where the invention provides a process involving multiple sequential steps, the invention can also provide a process involving less than the total number of steps. For example, if a saccharide has already been partially purified by removing contaminating nucleic acids and/or proteins then this step can be omitted from the processes of the invention. Similarly, a step of removing contaminants can be performed to give material ready for detergent-mediated precipitation, but the precipitation need not be performed. The precipitation step need not be performed in order to fall within the scope of the invention, as the pre-precipitation material has utility as an intermediate in saccharide preparation, and may be used, stored, exported, etc. for later use e.g. for later precipitation. These different steps can be performed at very different times by different people in different places (e.g. in different countries).

It will be appreciated that sugar rings can exist in open and closed form and that, whilst closed forms are shown in structural formulae herein, open forms are also encompassed by the invention. Similarly, it will be appreciated that sugars can exist in pyranose and furanose forms and that, whilst pyranose forms are shown in structural formulae herein, furanose forms are also encompassed. Different anomeric forms of sugars are also encompassed.

### BRIEF DESCRIPTION OF DRAWINGS

FIG. 1 illustrates the capsular polysaccharide (left) and the group-specific polysaccharide (right) attached to the peptidoglycan of GBS.

FIG. 2 shows the repeating structures of capsular saccharides in GBS serotypes Ia, Ib, II, III & V.

FIG. 3 shows the difference between the repeating structures in GBS serotypes Ia and III.

FIG. 4 shows the tetraantennary structure of the group B antigen. A-D represent the major component oligosaccharides, and P represents phosphate [12].

FIG. 5 shows two types of conjugate that can be prepared.

FIG. 6 is a flowchart showing an overall process of the invention.

FIG. 7 is a UV absorbance spectrum of six GBS capsular polysaccharide presentations. A peak or shoulder is visible at around 275 nm. At that point, the top three spectra are for material purified by prior art methods, and the bottom three spectra are for material purified according to the invention. In order from top to bottom at the ˜275 nm point: Ib; Ia; III; Ia; Ib; III.

FIGS. 8 to 10 show NMR spectra for different serotypes: (8) Ia; (9) Ib; (10) III.

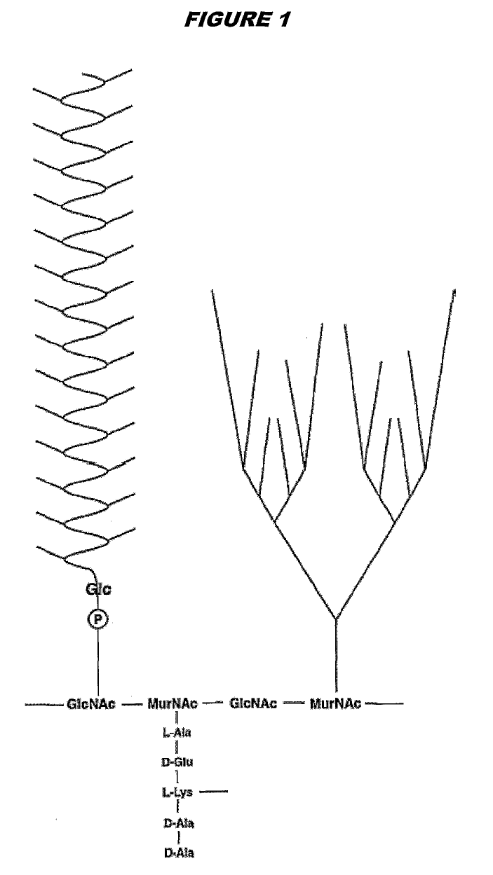

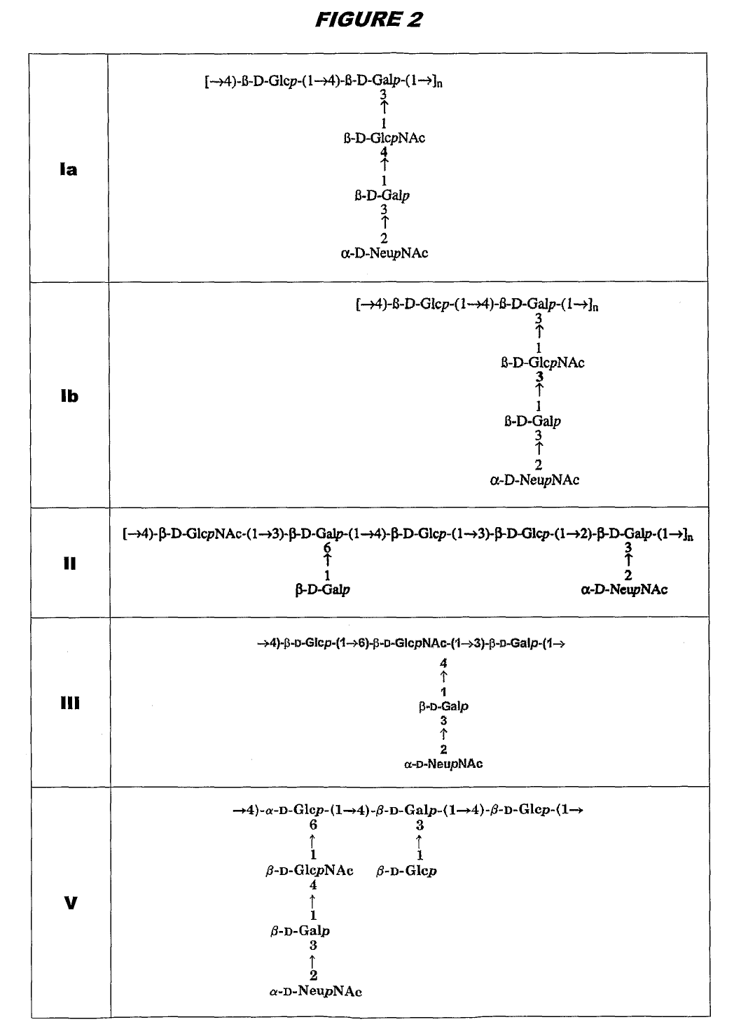

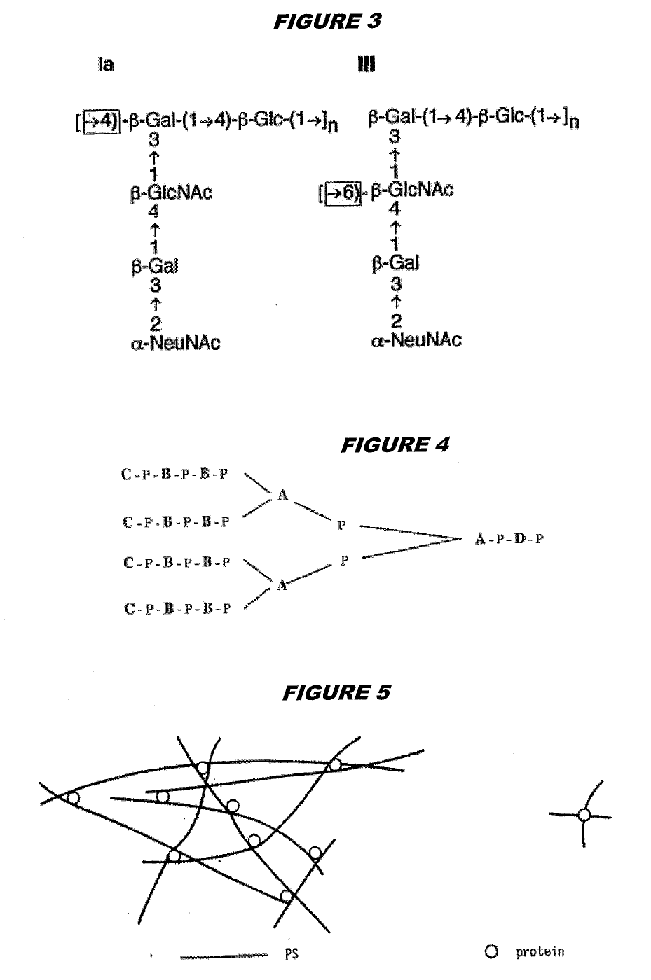

### MODES FOR CARRYING OUT THE INVENTION

### A. Purification of Capsular Saccharide from GBS Serotypes Ia, Ib and III

The supernatant of a group B streptococcus culture was collected after centrifugation and was treated with sodium hydroxide (final concentration 0.8M) at 37° C. for 36 hours. The resulting suspension was neutralised by addition of HCl. A mixture of aqueous ethanol (30%) and CaCl₂ (0.1M) was added to the neutralised mixture. A precipitate rapidly formed, which was removed by centrifugation. Sialic acid assays showed that the capsular saccharide remained in the supernatant. The supernatant was subjected to dead-end microfiltration in regenerated cellulose filters (0.22 μm cut-off), and was then subjected to tangential flow diafiltration using a 30 kDa cut-off cellulose membrane for around 2 hours. The capsular saccharide was in the ultrafiltration retentate. The retentate was treated by adding 10% CTAB detergent until a precipitate formed (within minutes). The precipitated material (including the capsular polysaccharide) was separated by centrifugation. The pellet was re-solubilised by addition of 0.1M aqueous CaCl₂. A further precipitation step was performed by adding 96% ethanol to give a final ethanol concentration of 80%. The precipitate was again removed by centrifugation, and the pellet was dried by vacuum drying.

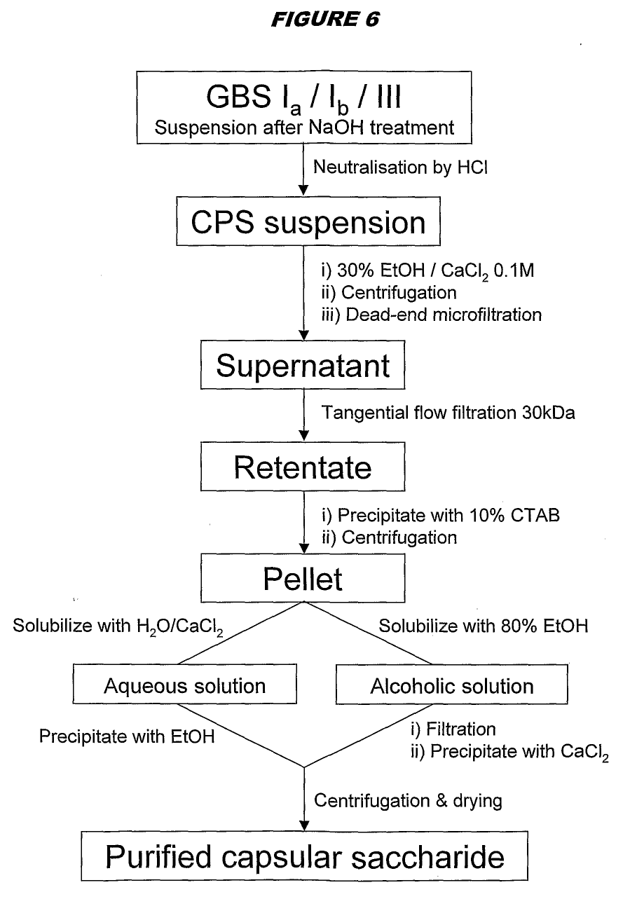

The overall process (illustrated in FIG. 6) took 2-3 days and had a yield of about 60%. For the final dried material the following parameters were tested: total weight; capsular saccharide weight; and sialic acid content. Results for the three serotypes were as follows:

| | | | Saccharide | |
|---|---|---|---|---|
| | Total w/v | Sialic acid | content | Purity |
| | (mg/ml)* | content (mg/ml) | (mg/ml) | (%) |
| Ia | 18.33 | 4.57 | 14.74 | 80.4 |
| Ib | 19.67 | 5.03 | 16.23 | 82.5 |
| III | 16.33 | 4.08 | 13.16 | 80.6 |

*Standard solution obtained by solubilising dried powder in water

The purity in each case was better than could be achieved by the prior art methods, particularly for the serotype III material (89% vs. 74%). In contrast to the prior art, however, the process took 2-3 days (compared to 15-20 days) and had a yield of about 60% (as compared to about 20%).

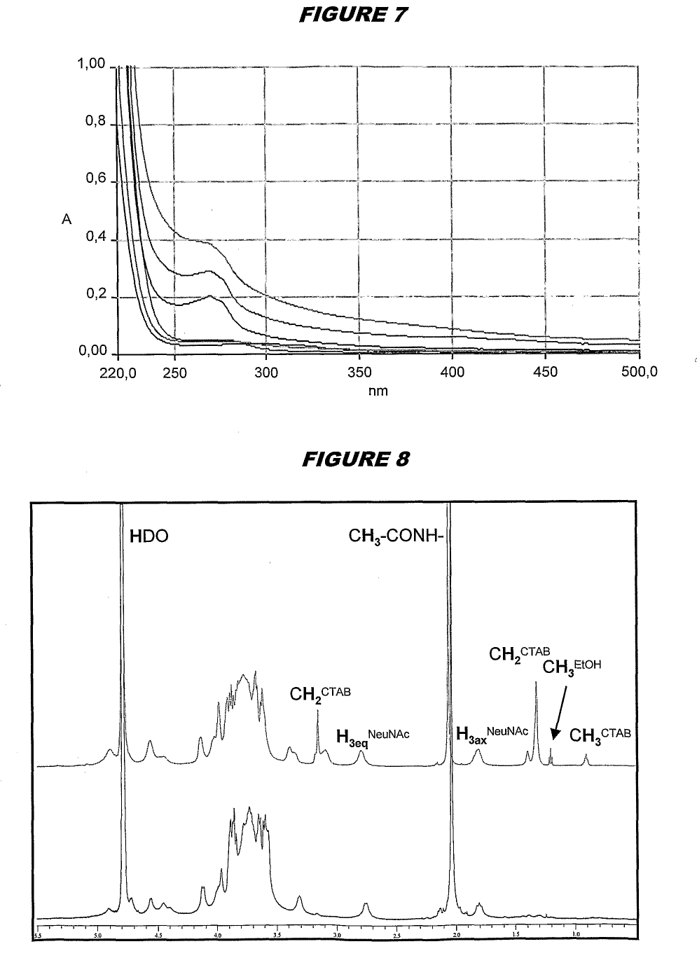

Contamination with proteins and nucleic acids was assessed by UV absorption. Saccharides prepared by the prior art processes were also tested for comparison. The spectra are shown in FIG. 7, and the prior art material has a clear peak at around 270 nm for each of the three serogroups. In contrast, material purified by the process of the invention has a flat spectrum in this region. The ratio of absorbances at 280 nm and 260 nm were as follows:

| Serotype | Prior art^{280 nm}/_{260 nm} | Invention^{280 nm}/_{260 nm} |
|---|---|---|
| Ia | 0.81 | 1.11 |
| Ib | 0.79 | 1.03 |
| III | 0.80 | 1.04 |

These ratios show that the material prepared by the methods of the invention is less contaminated than material prepared by the methods of the prior art.

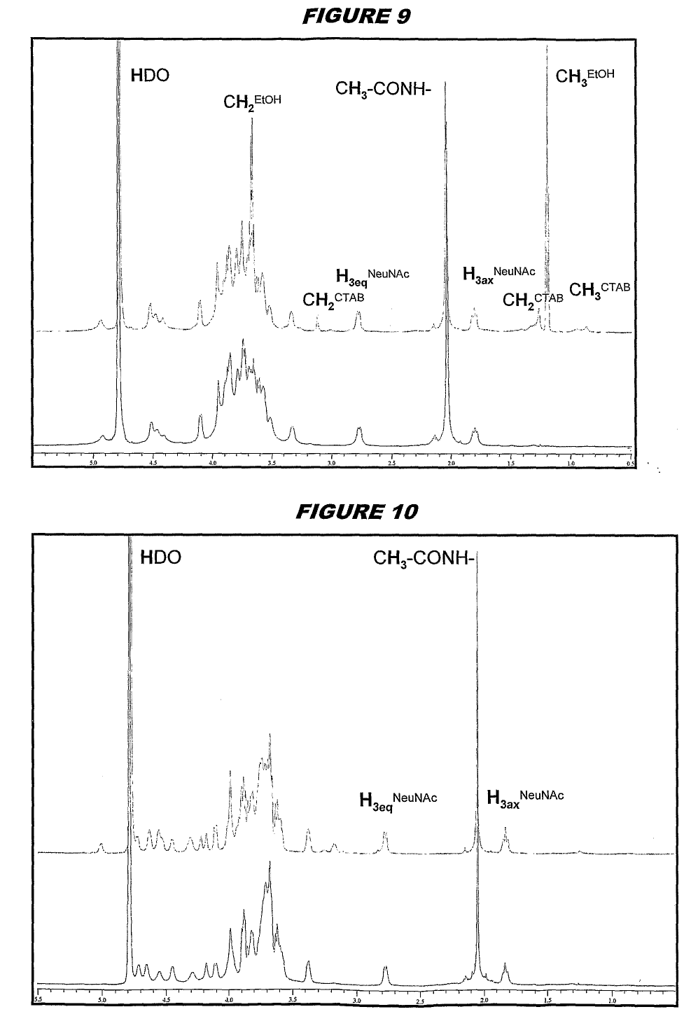

NMR was used to study the saccharides and, in particular, to assess the degree of N-acetylation. The NMR spectra are shown in FIGS. 8 to 10. The spectra for the prior art process and the invention's process are overlaid, with the lower spectrum being the prior art material. The calculated % s N-acetylation were as follows:

| Serotype | Prior art^{%} | Invention^{%} |
|---|---|---|
| Ia | 95.5 | 52.0 |
| Ib | 76.4 | 85.4 |
| III | 77.9 | 66.0 |

### B. Conjugation of Purified Capsular Saccharides

Capsular saccharides from each of GBS serotypes Ia, Ib and III were purified and re-acetylated. The saccharides were then covalently conjugated either to monomeric tetanus toxoid (TT) or to CRM197 carrier proteins by direct reductive amination. Results were as follows:

| | | Saccharide | Carrier | Saccharide/ |
|---|---|---|---|---|
| Conjugate | % Oxidation | (mg/ml) | (mg/ml) | Protein ratio (w/w) |
| Ia-TT | 10.8 | 2.033 | 0.865 | 2.35 |
| Ia-CRM | 9.1 | 1.156 | 0.401 | 2.88 |
| Ib-TT | 15.2 | 1.740 | 1.271 | 1.37 |
| Ib-CRM | 8.2 | 0.898 | 0.448 | 2.00 |
| III-TT | 14.3 | 0.964 | 0.631 | 1.53 |
| III-CRM | 6.5 | 1.105 | 0.626 | 1.77 |

### C. Challenge Studies with Conjugates

Capsular saccharide from a serotype Ia strain was purified either using the prior art processes or by the methods of the invention. For conjugation, a fraction of the sialic acid residues in the saccharide was oxidised, with a target of between 5 and 15%.

Two lots of material purified by the prior art methods had oxidation percentages of 54.5% and 17.6%. Material purified according to the invention was 6.6% oxidised.

The saccharides were conjugated to tetanus toxoid by reductive amination. Immunizations of mice were performed in parallel with the three conjugates at 0 and 21 days with 1 μg saccharide per dose. Groups of CD-1 outbred female mice 6-7 weeks old (Charles River Laboratories) received the conjugate suspended in 250 μl PBS and an equal volume of PBS containing an aluminium hydroxide adjuvant (2 mg/ml final concentration) by intra-peritoneal injection. Mice were then challenged with three different serotypes. Survival rates were as follows:

| | Challenge strain | | |
|---|---|---|---|
| Saccharide | A909 | 515 | 090 |
| Prior art, 54.5% | 7 | 24 | 18 |
| Prior art, 17.6% | 100 | 47 | 50 |
| Invention, 5.5% | 100 | 97 | 93 |
| PBS control | 12 | 17 | 0 |

Thus saccharides purified by the process of the invention are immunologically superior to those purified by prior art methods.

### Opsonophagocytosis Studies

TT-conjugates saccharides from serotypes Ia, Ib and III were prepared, either by the prior art methods [1-9] or by the methods of the invention. Groups of four CD-1 outbred female mice 6-7 weeks old (Charles River Laboratories) were immunized with the conjugates (dose: 1 μg saccharide) suspended in 250 μl PBS and an equal volume of PBS containing an aluminium hydroxide adjuvant (2 mg/ml final concentration). Each group received two doses at days 0 and 21 by intra-peritoneal injection. In each immunization scheme negative and positive control groups were also used.

Immune responses were determined from serum samples taken on days 0 and 36. The sera were analyzed as pools from each group of mice, against 7 different GBS strains, including ‘515’ (type Ia; MLST type ST23), ‘COH1’ (type III; MLST type ST17) and ‘H36B’ (type Ib; MLST type ST6). Both protection and the opsonic titres were measured, and results were as follows:

| Serotype | Challenge strain | | | |
|---|---|---|---|---|
| Conjugation | Protection (%) | | | Opsonic titre |
| Ia | COH1 | M781 | — | |
| Invention | 100 | 92 | — | 1400 |
| Prior art | 100 | — | — | 380 |
| PBS control | 15 | 17 | — | — |
| Ib | 7357b | H36B | — | |
| Invention | 95 | 87 | — | 6500 |
| Prior art | 90 | — | — | 500 |
| PBS control | 25 | 0 | — | — |
| III | 515 | 090 | A909 | |
| Invention | 93 | 95 | 100 | 2150 |
| Prior art | 47 | 50 | 100 | 300 |
| PBS control | 5 | 0 | 17 | — |

The data show that the saccharides purified by the methods of the invention give equivalent or improved protective efficacy compared to the material purified by prior art methods. Moreover, where protective efficacy is comparable, material purified by the methods of the invention gives improved opsonic titres.

It will be understood that the invention has been described by way of example only and modifications may be made whilst remaining within the scope and spirit of the invention.

### REFERENCES

### The Contents of which are Hereby Incorporated in Full

[1] Paoletti et al. (1990) J Biol Chem 265:18278-83.
[2] Wessels et al. (1990) J Clin Invest 86:1428-33.
[3] Paoletti et al. (1992) Infect Immun 60:4009-14.
[4] Paoletti et al. (1992) J Clin Invest 89:203-9.
[5] Wessels et al. (1987) Proc Natl Acad Sci USA 84:9170-4.
[6] Wang et al. (2003) Vaccine 21:1112-7.
[7] Wessels et al. (1993) Infect Immun 61:4760-6
[8] Wessels et al. (1995)J Infect Dis 171:879-84.
[9] Baker et al. (2004) J Infect Dis 189:1103-12.
[10] Wessels et al. (1989) Infect Immun 57:1089-94.
[11] WO02/00249.
[12] Deng et al. (2000) J Biol Chem 275:7497-04.
[13] U.S. Pat. Nos. 6,027,733 & 6,274,144.
[14] www.polymer.de
[15] Lewis et al. (2004) PNAS USA 101:11123-8.
[16] U.S. Pat. No. 6,248,570.
[17] Inzana (1987) Infect. Immun. 55:1573-79.
[18] Wessels et al. (1998) Infect Immun 66:2186-92.
[19] Ramsay et al. (2001) Lancet 357(9251):195-196.
[20] Lindberg (1999) Vaccine 17 Suppl 2:S28-36.
[21] Buttery & Moxon (2000) J R Coll Physicians Lond 34:163-68.
[22] Ahmad & Chapnick (1999) Infect Dis Clin North Am 13:113-33, vii.
[23] Goldblatt (1998) J. Med. Microbiol. 47:563-7.
[24] European patent 0477508.
[25] U.S. Pat. No. 5,306,492.
[26] WO98/42721.
[27] Dick et al. in Conjugate Vaccines (eds. Cruse et al.) Karger, Basel, 1989, 10:48-114.
[28] Hermanson Bioconjugae Techniques, Academic Press, San Diego (1996) ISBN: 0123423368.
[29] U.S. Pat. No. 4,356,170.
[30] Paoletti & Kasper (2003) Expert Opin Biol Ther 3:975-84.
[31] International patent application PCT/IB05/______, ‘CONJUGATION OF STREPTOCOCCAL CAPSULAR SACCHARIDES’, claiming priority from GB-0502095.3 (in CHIRON SRL).
[32] Anonymous (January 2002) Research Disclosure, 453077.
[33] Anderson (1983) Infect Immun 39(1):233-8.
[34] Anderson et al. (1985) J Clin Invest 76(1):52-9.
[35] EP-A-0372501.
[36] EP-A-0378881.
[37] EP-A-0427347.
[38] WO93/17712
[39] WO94/03208.
[40] WO98/58668.
[41] EP-A-0471177.
[42] WO91/01146
[43] Falugi et al. (2001) Eur J Immunol 31:3816-24.
[44] Baraldo et al. (2004) Infect Immun 72(8):4884-7.
[45] EP-A-0594610.
[46] WO00/56360.
[47] WO02/091998.
[48] Kuo et al. (1995) Infect Immun 63:2706-13.
[49] WO01/72337
[50] WO00/61761.
[51] WO99/42130.
[52] WO2004/011027.
[53] WO96/40242.
[54] Lei et al. (2000) Dev Biol (Basel) 103:259-264.
[55] WO00/38711; U.S. Pat. No. 6,146,902.
[56] WO94/06467.
[57] WO99/24578.
[58] WO99/36544.
[59] WO99/57280.
[60] WO00/22430.
[61] Tettelin et al. (2000) Science 287:1809-1815.
[62] WO96/29412.
[63] Pizza et al. (2000) Science 287:1816-1820.
[64] WO01/52885.
[65] Bjune et al. (1991) Lancet 338(8775):1093-1096.
[66] Fukasawa et al. (1999) Vaccine 17:2951-2958.
[67] Rosenqvist et al. (1998) Dev. Biol. Stand. 92:323-333.
[68] Costantino et al. (1992) Vaccine 10:691-698.
[69] WO03/007985.
[70] Watson (2000) Pediatr Infect Dis J 19:331-332.
[71] Rubin (2000) Pediatr Clin North Am 47:269-285, v.
[72] Jedrzejas (2001) Microbiol Mol Biol Rev 65:187-207.
[73] Bell (2000) Pediatr Infect Dis J 19:1187-1188.
[74] Iwarson (1995) APMIS 103:321-326.
[75] Gerlich et al. (1990) Vaccine 8 Suppl:S63-68 & 79-80.
[76] Hsu et al. (1999) Clin Liver Dis 3:901-915.
[77] Gustafsson et al. (1996) N. Engl. J. Med. 334:349-355.
[78] Rappuoli et al. (1991) TIBTECH 9:232-238.
[79] Vaccines (2004) eds. Plotkin & Orenstein. ISBN 0-7216-9688-0.
[80 ] WO02/02606.
[81 ] Kalman et al. (1999) Nature Genetics 21:385-389.
[82 ] Read et al. (2000) Nucleic Acids Res 28:1397-406.
[83 ] Shirai et al. (2000) J. Infect. Dis. 181(Suppl 3):S524-S527.
[84 ] WO99/27105.
[85 ] WO00/27994.
[86 ] WO00/37494.
[87 ] WO99/28475.
[88 ] Ross et al. (2001) Vaccine 19:4135-4142.
[89 ] Sutter et al. (2000) Pediatr Clin North Am 47:287-308.
[90 ] Zimmerman & Spann (1999) Am Fam Physician 59:113-118, 125-126.
[91 ] Dreesen (1997) Vaccine 15 Suppl:S2-6.
[92 ] MMWR Morb Mortal Wkly Rep 1998 Jan. 16; 47(1):12, 19.
[93 ] McMichael (2000) Vaccine 19 Suppl 1:S101-107.
[94 ] WO02/34771.
[95 ] Dale (1999) Infect Dis Clin North Am 13:227-43, viii.
[96] Ferretti et al. (2001) PNAS USA 98: 4658-4663.
[97 ] Robinson & Torres (1997) Seminars in Immunology 9:271-283.
[98 ] Donnelly et al. (1997) Annu Rev Immunol 15:617-648.
[99 ] Scott-Taylor & Dalgleish (2000) Expert Opin Investig Drugs 9:471-480.
[100] Apostolopoulos & Plebanski (2000) Curr Opin Mol Ther 2:441-447.
[101] Ilan (1999) Curr Opin Mol Ther 1:116-120.
[102] Dubensky et al. (2000) Mol Med 6:723-732.
[103] Robinson & Pertmer (2000) Adv Virus Res 55:1-74.
[104] Donnelly et al. (2000)Am J Respir Crit Care Med 162(4 Pt 2):S190-193.
[105] Davis (1999) Mt. Sinai J. Med. 66:84-90.
[106] Gennaro (2000) Remington: The Science and Practice of Pharmacy. 20th edition, ISBN: 0683306472.
[107] WO03/093306.
[108] WO2004/018646.
[109] WO2004/041157.
[110] Geysen et al. (1984) PNAS USA 81:3998-4002.
[111] Carter (1994) Methods Mol Biol 36:207-23.
[112] Jameson, B A et al. 1988, CABIOS 4(1):181-186.
[113] Raddrizzani & Hammer (2000) Brief Bioinform 1(2):179-89.
[114] De Lalla et al. (1999) J. Immunol. 163:1725-29.
[115] Brusic et al. (1998) Bioinformatics 14(2):121-30
[116] Meister et al. (1995) Vaccine 13(6):581-91.
[117] Roberts et al. (1996) AIDS Res Hum Retroviruses 12(7):593-610.
[118] Maksyutov & Zagrebelnaya (1993) Comput Appl Biosci 9(3):291-7.
[119] Feller & de la Cruz (1991) Nature 349(6311):720-1.
[120] Hopp (1993) Peptide Research 6:183-190.
[121] Welling et al. (1985) FEBS Lett. 188:215-218.
[122] Davenport et al. (1995) Immunogenetics 42:392-297.
[123] Bodanszky (1993) Principles of Peptide Synthesis (ISBN: 0387564314).
[124] Fields et al. (1997) Meth Enzymol 289: Solid-Phase Peptide Synthesis. ISBN: 0121821900.
[125] Chan & White (2000) Fmoc Solid Phase Peptide Synthesis. ISBN: 0199637245.
[126] Kullmann (1987) Enzymatic Peptide Synthesis. ISBN: 0849368413.
[127] Ibba (1996) Biotechnol Genet Eng Rev 13:197-216.
[128] Qi Chen et al. (2002) Infect Immun 70:6409-15.
[129] Beckmann et al. (2002) Infect Immun 70:2869-76.
[130] Cheng et al. (2002) Infect Immun 70:2408-13.
[131] Cheng et al. (2001) Infect Immun 69:2302-8.

1. A process for purifying a Streptococcus agalactiae capsular polysaccharide, comprising the steps of: (a) treating a suspension comprising streptococcal proteins, nucleic acids and capsular polysaccharide with an aqueous metal cation and an alcohol in order to precipitate nucleic acids and proteins; (b) separating the precipitated material from the aqueous material; and (c) treating the aqueous material with a cationic detergent in order to precipitate the capsular polysaccharide.

2. The process of claim 1, wherein the polysaccharide is from a S. agalactiae serotype selected from Ia, Ib, II, III, IV, V, VI, VII or VIII.

3. The process of claim 2, wherein the serotype is selected from Ia, Ib, II, III or V.

4. The process of any preceding claim, wherein the polysaccharide is a substantially full-length capsular polysaccharide.

5. The process of any preceding claim, wherein the polysaccharide has a molecular weight >30 kDa.

6. The process of any preceding claim, wherein the saccharide is partially or fully de-O-acetylated.

7. The process of any preceding claim, wherein the saccharide is partially or fully de-N-acetylated.

8. The process of any preceding claim, wherein the suspension is the supernatant from a centrifuged S. agalactiae culture.

9. The process of any one of claims 1 to 7, wherein the suspension is prepared by treating S. agalactiae such that the capsular saccharide is released.

10. The process of claim 9, wherein the capsular saccharide is released by chemical or enzymatic treatment.

11. The process of claim 10, wherein the capsular saccharide is released by base extraction.

12. The process of claim 10, wherein the capsular saccharide is released by treatment with both mutanolysin and β-N-acetylglucosaminidase.

13. The process of claim 10, wherein the capsular saccharide is released by treatment with a type II phosphodiesterase.

14. The process of any preceding claim, wherein the alcohol is a lower alcohol.

15. The process of claim 14, wherein the alcohol is ethanol or isopropanol.

16. The process of any preceding claim, wherein the alcohol is added to the suspension to give a final alcohol concentration of between 10% and 50%.

17. The process of any preceding claim, wherein the aqueous metal cation is monovalent or divalent.

18. The process of claim 17, wherein the cation is Mg⁺⁺, Mn⁺⁺ or Ca⁺⁺.

19. The process of claim 18, where Ca⁺⁺ ions are used and are present at a final concentration of between 10 and 500 mM.

20. The process of any preceding claim, wherein step (b) includes centrifugation.

21. The process of claim 20, wherein the supernatant after centrifugation is subjected to microfiltration.

22. The process of any preceding claim, wherein a step of diafiltration is performed after step (a) and before step (c).

23. The process of any preceding claim, wherein the cationic step in step (c) is a tetrabutylammonium or cetyltrimethylammonium salt, such as CTAB.

24. The process of any preceding claim, wherein the process further comprises re-solubilising the saccharide into aqueous medium or into alcoholic medium.

25. The process of claim 24, wherein an aqueous medium is used for re-solubilising the saccharide, and wherein the aqueous medium includes Mg⁺⁺, Mn⁺⁺ or Ca⁺⁺.

26. The process of claim 24, wherein an alcoholic medium is used for re-solubilising the saccharide, and wherein the alcohol has a final concentration of between 70% and 95%.

27. A composition comprising a Streptococcus agalactiae capsular polysaccharide, obtainable by the process of any preceding claim.

28. The composition of claim 27, wherein the composition has UV absorbance at 280 nm of less than 0.20.

29. The composition of claim 27, wherein the ratio of UV absorbance of the composition at 280 nm to the UV absorbance at 260 nm is greater than 0.85.

30. The composition of claim 27, wherein the UV absorbance spectrum of the composition between 220 nm and 300 nm does exhibit either a shoulder or peak at around 270 nm.

31. The composition of claim 27, wherein the UV spectrum of the composition between 250 nm and 275 nm has neither a maximum point nor a point of inflexion.

32. The composition of claim 27, wherein the purity of the saccharide is at least 89% relative to the total weight of saccharide, protein and nucleic acid in the composition.
